(19) United States
(12) Patent Application Publication
(10) Pub. No.: US 2023/0180300 A1
(43) Pub. Date: Jun. 8, 2023

(54) FIRST MESSAGE DIFFERENTIATION IN CFRA PROCEDURE

(71) Applicant: Telefonaktiebolaget LM Ericsson (publ), Stockholm (SE)

(72) Inventors: Zhipeng LIN, Nanjing, Jiangsu (CN); Jingya LI, Göteborg (SE); Henrik SAHLIN, Mölnlycke (SE)

(73) Assignee: Telefonaktiebolaget LM Ericsson publ), Stockholm (SE)

(21) Appl. No.: 17/995,169

(22) PCT Filed: Apr. 28, 2021
(86) PCT No.: PCT/EP2021/061194

§ 371 Date: Sep. 30, 2022

(30) Foreign Application Priority Data
Apr. 29, 2020 (CN) PCT/CN2020/087790

(51) Int. Cl. H04W 74/08; H04W 74/04

(52) U.S. Cl. CPC H04W 74/0833; H04W 74/04; H04W 74/0891

(57) ABSTRACT

For contention free random access (CFRA) with 2-step RA type or 4-step RA type, a network node may configure different physical random access preamble configurations (e.g., different PRACH occasions, preamble index, or preamble format) for different user equipment (UE)/service groups that are associated with different UE priorities, UE types, service priorities, service types, and/or network slices. A UE may select a configuration to use to transmit the random access preamble based on the priority of the UE, the type of the UE, the priority of the service, the type of the service, and/or the network slice. In 2-step RACH, a network node may also configure different msgA PUSCH resources for different UE priorities, UE types, service priorities, service types, and/or network slices.

### TECHNICAL FIELD

This disclosure relates to apparatuses, methods, and systems for collision free random access procedures. Some aspects of this disclosure relate to first and second physical random access channel (PRACH) configurations that enable differentiated admission control based on a user equipment (UE) priority, a UE type, a service priority, a service type, and/or a network slice.

### BACKGROUND

1.1. New Radio Initial Access

The New Radio (NR) (a.k.a. 5G or Next Generation (NG)) architecture may include one or more of a user equipment (UE) and a network node (e.g., an NG NodeB (gNB)). The network node may be a 5G node. Before the user equipment (UE) can properly communicate within a network, the UE must carry out a cell search to find, synchronize, and identify a cell. After finding, synchronizing, and identifying a cell, the UE can acquire basic system information and perform a random access procedure to establish a connection to the cell.

1.1.1. NR Cell Search and System Information Acquisition

In NR, the combination of synchronization signals (SS) and physical broadcast channel (PBCH) is referred to as an SS/PBCH block (SSB). Similar to Long Term Evolution (LTE), a pair of SS, primary synchronization signal (PSS) and secondary synchronization signal (SSS), is periodically transmitted on downlink from each cell to allow a UE to initially access to the network. By detecting SS, a UE can obtain the physical cell identity, achieve downlink synchronization in both time and frequency, and acquire the timing for PBCH. PBCH carries the master information block (MIB), which contains minimum system information that a UE needs to acquire system information block 1 (SIB 1). SIB1 carries the remaining minimum system information that is needed for a UE to be able to perform a subsequent random-access procedure.

1.1.2. NR Random Access Procedure

Two types of random access procedure are supported: (1) 4-step random access (RA) type with Msg1 and (2) 2-step RA type with MSGA. Both types of RA procedure support contention-based random access (CBRA) and contention-free random access (CFRA).

The 4-step random access procedure, also referred to as Type-1 random access procedure in Technical Specification (TS) 38.213, is illustrated in FIG. 1. In the first step, a UE 102 initiates the random-access procedure by transmitting in uplink (UL) a random-access preamble (called Msg 1) on a physical random-access channel (PRACH). After detecting the Msg1, a network node 104 (e.g., gNB) will respond by transmitting in downlink (DL) a random-access response (RAR) on a physical downlink shared channel (PDSCH) (called Msg2). In the third step, after successfully decoding Msg2, the UE 102 continues the procedure by transmitting in UL a physical uplink shared channel (PUSCH) (called Msg3) for terminal identification and Radio Resource Control (RRC) connection establishment request. In the last step of the procedure, the network node 104 transmits in DL a PDSCH (called Msg4) for contention resolution.

There can be cases that multiple UEs select the same random-access preamble and transmit the preamble on the same PRACH time/frequency resource. This preamble collision is called contention. One of the main purposes of Steps 3 and 4 of the 4-step random access procedure is to resolve such potential contention.

The 2-step random access procedure, also referred to as Type-2 random access procedure in TS 38.213, is illustrated in FIG. 2. In the first step, a UE 102 sends a message A (MsgA) including a random access preamble together with higher layer data such as an RRC connection request and possibly with some small payload on PUSCH. In the second step, after detecting the MsgA, the network node 104 sends a RAR (called message B) including UE identifier assignment, timing advance information, and contention resolution message etc.

FIG. 3A illustrates a CFRA procedure with 4-step RA type, and FIG. 3B illustrates a CFRA procedure with 2-step RA type. As shown in FIG. 3A, the network node 104 assigns a preamble for CFRA in 4-step RACH, and, as shown in FIG. 3B, the network node 104 assigns a preamble and PUSCH for CFRA in 2-step RACH. The network node 104 does not configure CFRA resources for 4-step and 2-step RA types at the same time for a Bandwidth Part (BWP). CF RA with 2-step RA type is only supported for handover.

The Msg1 of 4-step RA type includes only a preamble on PRACH, while the MSGA of the 2-step RA type includes a preamble on PRACH and a payload on PUSCH. After Msg1 transmission or MSGA transmission, the UE 102 monitors for a response from the network node 104 within a configured window. For CFRA, upon receiving the network response, the UE 102 ends the random access procedure.

1.2. NR Rel-15 PRACH Configuration

In NR, the time and frequency resource on which a random-access preamble (Msg 1) is transmitted is defined as a PRACH occasion.

The time resources and preamble format for the Msg1 transmission is configured by a PRACH configuration index, which indicates a row in a PRACH configuration table specified in TS 38.211 Tables 6.3.3.2-2, 6.3.3.2-3, 6.3.3.2-4 for FR1 paired spectrum, FR1 unpaired spectrum, and FR2 with unpaired spectrum, respectively.

Part of the Table 6.3.3.2-3 for FR1 unpaired spectrum for preamble format 0 is copied in Table 1 below, where the value of x indicates the PRACH configuration period in number of system frames. The value of y indicates the system frame within each PRACH configuration period on which the PRACH occasions are configured. For instance, if y is set to 0, then, it means PRACH occasions only configured in the first frame of each PRACH configuration period. The values in the column “subframe number” tells on which subframes are configured with PRACH occasion. The values in the column “starting symbol” is the symbol index

In case of time division duplex (TDD), semi-statically configured DL parts and/or actually transmitted SSBs can override and invalidate some time-domain PRACH occasions defined in the PRACH configuration table. More specifically, PRACH occasions in the UL part are always valid, and a PRACH occasion within the X part is valid as long as (i) it does not precede or collide with an SSB in the RACH slot and (ii) it is at least N symbols after the DL part and the last symbol of an SSB. N is 0 or 2 depending on PRACH format and subcarrier spacing.

TABLE 1
PRACH configuration for preamble format 0 for FR1 unpaired spectrum

| | | | | | | | Nₜ^{RA, slot}, | |
|---|---|---|---|---|---|---|---|---|
| | | | | | | | number | |
| | | | | | | | of time- | |
| | | | | | | Number | domain | |
| | | | | | | of PRACH | PRACH | |
| PRACH | | n_{SFN} | | | | slots | occasions | N_{dur}^{RA}, |
| Configuration | Preamble | mod x = y | | Subframe | Starting | within a | within a | PRACH |
| Index | format | x | y | number | symbol | subframe | PRACH slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | | | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |

In the frequency domain, NR supports multiple frequency-multiplexed PRACH occasions on the same time-domain PRACH occasion. This is mainly motivated by the support of analog beam sweeping in NR such that the PRACH occasions associated to one SSB are configured at the same time instance but different frequency locations. The starting position in the frequency is indicated by the higher-layer parameter msg1-FrequencyStart in SIB1, and the number of consecutive PRACH occasions frequency division multiplexed (FDMed) in one time instance is configured by the higher-layer parameter msg1-FDM in SIB1. The number of PRACH occasions FDMed in one time domain PRACH occasion, can be 1, 2, 4, or 8.

Here the msg1-FDM and msg1-FrequencyStart are defined in 3GPP TS 38.331 as below: msg1-FDM: The number of PRACH transmission occasions FDMed in one time instance. msg1-FrequencyStart: Offset of lowest PRACH transmission occasion in frequency domain with respective to PRB 0. The value is configured so that the corresponding RACH resource is entirely within the bandwidth of the UL BWP.

### RACH-ConfigGeneric Information Element

-- ASN1START
-- TAG-RACH-CONFIG-GENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks-1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, n100, n200}, |
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

...
}
-- TAG-RACH-CONFIG-GENERIC-STOP
-- ASN1STOP

FIG. 4 gives an example of the PRACH occasion configuration in NR.

In NR Rel-15, there are up to 64 sequences that can be used as random-access preambles per PRACH occasion in each cell. The RRC parameter totalNumberOfRA-Preambles determines how many of these 64 sequences are used as random-access preambles per PRACH occasion in each cell. The 64 sequences are configured by including firstly all the available cyclic shifts of a root Zadoff-Chu sequence, and secondly in the order of increasing root index, until 64 preambles have been generated for the PRACH occasion.

1.2.1. NR Rel-15 Association Between SSB and PRACH Occasion

NR Rel-15 supports one-to-one, one-to-many, and many-to-one association between SSB and PRACH occasions, as illustrated in FIGS. 5 and 6.

The preambles associated to each SSB are configured by the two RRC parameters in the RACH-ConfigCommon: ssb-perRACH-OccasionAndCB-PreamblesPerSSB and totalNumberOfRA-Preambles. The detailed mapping rule is specified in TS 38.213 section 8.1, as following:
For Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB.
A UE is provided a number N of SS/PBCH blocks associated with one PRACH occasion and a number R of contention-based preambles per SS/PBCH block per valid PRACH occasion by ssb-perRACH-OccasionAndCB-PreamblesPerSSB. If N<1, one SS/PBCH block is mapped to 1/N consecutive valid PRACH occasions and R contention based preambles with consecutive indexes associated with the SS/PBCH block per valid PRACH occasion start from preamble index 0. If N≥1, R contention based preambles with consecutive indexes associated with SS/PBCH block n, 0≤n≤N−1, per valid PRACH occasion start from preamble index n·N_{preamble}^{total}/N where N_{preamble}^{total} is provided by totalNumberOfRA-Preambles and is an integer multiple of N.
SS/PBCH block indexes provided by ssb-PositionsInBurst in SIB1 or in ServingCellConfigCommon are mapped to valid PRACH occasions in the following order where the parameters are described in [4, TS 38.211].
   First, in increasing order of preamble indexes within a single PRACH occasion
   Second, in increasing order of frequency resource indexes for frequency multiplexed PRACH occasions
   Third, in increasing order of time resource indexes for time multiplexed PRACH occasions within a PRACH slot
   Fourth, in increasing order of indexes for PRACH slots

FIG. 7 shows an example of the mapping between SSBs and preambles in different PRACH occasions.

For each SSB, the associated preambles per PRACH occasion, N_{preamble}^{total}/N, are further divided into two sets for Contention Based Random Access (CBRA) and Contention Free Random Access (CFRA). The number of CB preambles per SSB per PRACH occasion, R, is signaled by the RRC parameter ssb-perRACH-OccasionAndCB-PreamblesPerSSB. Preamble indices for CBRA and CFRA are mapped consecutively for one SSB in one PRACH occasion, as shown in FIG. 8.

If Random Access Preambles group B is configured for CBRA, then, amongst the CBRA preambles (#CB-preambles-per-SSB) associated with an SSB, the first numberOfRA-PreamblesGroupA Random Access Preambles belong to Random Access Preambles group A, and the remaining Random Access Preambles associated with the SSB belong to Random Access Preambles group B. FIG. 9 shows an example, when Random Access Preambles group B is configured for CBRA. The RACH-ConfigCommon information element is shown below.

-- ASN1START
-- TAG-RACH-CONFIGCOMMON-START

| | |
|---|---|
| RACH-ConfigCommon ::= | SEQUENCE { |
| Rach-ConfigGeneric | RACH-ConfigGeneric, |
| totalNumberOfRA-Preambles | INTEGER (1 . . 63) OPTIONAL, --Need S |
| ssb-perRACH-OccasionANDCB-PreamblesPerSSB | CHOICE { |
| oneEighth | ENUMERATED {n4, n8, n12, n16, |
| | n20, n24, n28, n32, n36, n40, |
| | n44, n48, n52, n56, n60, n64}, |
| oneFourth | ENUMERATED {n4, n8, n12, n16, |
| | n20, n24, n28, n32, n36, n40, |
| | n44, n48, n52, n56, n60, n64}, |
| oneHalf | ENUMERATED {n4, n8, n12, n16, |
| | n20, n24, n28, n32, n36, n40, |
| | n44, n48, n52, n56, n60, n64}, |
| one | ENUMERATED {n4, n8, n12, n16, |
| | n20, n24, n28, n32, n36, n40, |
| | n44, n48, n52, n56, n60, n64}, |
| two | ENUMERATED {n4, n8, n12, n16, |
| | n20, n24, n28, n32}, |
| four | INTEGER (1 . . 16), |
| eight | INTEGER (1 . . 8), |
| sixteen | INTEGER (1 . . 4), |
| } | OPTIONAL, -- Need M |
| groupBconfigured | SEQUENCE { |
| ra-Msg3SizeGroupA | ENUMERATED {b56, b144, b208, b256, b282, |
| | b480, b640, b800, b1000, b72, spare6, |
| | spare5, spare4, spare3, spare2, spare1}, |
| messagePowerOffsetGroupB | ENUMERATED { minusinfinity, dB0, dB5, dB8, |
| | dB10, dB12, DB15, dB18}, |
| numberOfRA-PreamblesGroupA | INTEGER (1 . . 64) |

}

According to TS 38.213, one of the two conditions must be met in order for a UE to select Random Access Preambles group B for PRACH transmission:

Condition 1: potential Msg3 size (UL data available for transmission plus MAC header and, where required, MAC CEs) is greater than ra-Msg3SizeGroupA and the pathloss is less than PCMAX (of the Serving Cell performing the Random Access Procedure)—preambleReceivedTargetPower—msg3-DeltaPreamble—messagePowerOffsetGroupB; or

Condition 2: the Random Access procedure was initiated for the CCCH logical channel and the CCCH SDU size plus MAC subheader is greater than ra-Msg3SizeGroupA.

1.3. RRC Establishment Cause for UE Differentiation

In step 3 of the 4-step random access procedure shown in FIG. 1, a UE includes the rrcSetupRequest message in Msg3. The rrcSetupRequest message contains the parameter, establishmentCause, which indicates the establishment cause that triggers the connection establishment (e.g., emergency call, mission critical services, multimedia priority services, etc.).

A network node 104 (e.g., a gNB) identifies the type of connection request from the UE by decoding the establishment cause received in msg3. Based on the received establishment clause, the network node 104 decides whether this request shall be admitted or rejected, based on the network traffic load situation and available resource in the network.

1.4. NR Rel-16 for MsgA Configuration

1.4.1. MsgA Preamble Configuration

The RACH occasions for 2-step RACH shown in FIG. 2 can be either separately configured (also known as Type-2 random access procedure with separate configuration of PRACH occasions with Type-1 random access procedure) or are shared with 4-step RACH (also known as Type-2 random access procedure with common configuration of PRACH occasions with Type-1 random access procedure) in which case different set of preamble IDs will be used.

For Type-2 random access procedure with common configuration of PRACH occasions with Type-1 random access procedure, a UE is provided a number N of SS/PBCH blocks associated with one PRACH occasion by ssb-perRACH-OccasionAndCB-PreamblesPerSSB and a number Q of contention based preambles per SS/PBCH block per valid PRACH occasion by msgA-CB-PreamblesPerSSB. The PRACH transmission can be on a subset of PRACH occasions associated with a same SS/PBCH block index for a UE provided with a PRACH mask index by msgA-ssb-sharedRO-MaskIndex. An example of the SSB to RO mapping and the preamble allocation (in which only one preamble group is assumed) is provided in FIG. 10.

For Type-2 random access procedure with separate configuration of PRACH occasions with Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB-msgA when provided; otherwise, by ssb-perRACH-OccasionAndCB-PreamblesPerSSB. Because the SSB to RO mapping and the preamble allocation are independently configured, the example provided for 4-step RACH in FIG. 9 is also valid for this case of 2-step RACH except that the parameters are separately configured for 2-step RACH.

1.4.2. MsgA PUSCH Configuration

A PUSCH occasion is defined as the time frequency resource used for one PUSCH transmission. For one msgA PUSCH occasion, one or more DMRS resources can be configured, one of which will be selected for each PUSCH transmission with in the PUSCH occasion.

A set of PUSCH occasions are configured per MsgA PUSCH configuration which are relative to and mapped by a group of preambles in a set of ROs in one PRACH slot. A mapping between one or multiple PRACH preambles and a PUSCH occasion associated with a DMRS resource is according to the mapping order as described below.

Each consecutive number of N_{preamble} preamble indexes from valid PRACH occasions in a PRACH slot
first, in increasing order of preamble indexes within a single PRACH occasion
second, in increasing order of frequency resource indexes for frequency multiplexed PRACH occasions
third, in increasing order of time resource indexes for time multiplexed PRACH occasions within a PRACH slot
   are mapped to a valid PUSCH occasion and the associated DMRS resource
first, in increasing order of frequency resource indexes f_{id} for frequency multiplexed PUSCH occasions
second, in increasing order of DMRS resource indexes within a PUSCH occasion, where a DMRS resource index DMRS_{id} is determined first in an ascending order of a DMRS port index and second in an ascending order of a DMRS sequence index [4, TS 38.211]
third, in increasing order of time resource indexes t_{id} for time multiplexed PUSCH occasions within a PUSCH slot
fourth, in increasing order of indexes for Nₛ PUSCH slots
   where N_{preamble}=ceil(T_{preamble}/T_{PUSCH}), T_{preamble} is a total number of valid PRACH occasions per association pattern period multiplied by the number of preambles per valid PRACH occasion provided by msgA-PUSCH-PreambleGroup, and T_{PUSCH} is a total number of valid PUSCH occasions per PUSCH configuration per association pattern period multiplied by the number of DMRS resource indexes per valid PUSCH occasion provided by msgA-DMRS-Config.

1.5. 5G Use Cases and Services

1.5.1. Mission Critical Communications

First responders, such as fire-fighters, policemen and emergency medical service personnel, require fast, reliable and secure communications in various mission critical (MC) situations. During major emergency incidents, such as nature disasters, there can be a high demand of MC traffic for supporting first responders' rescue operation on site. At the same time, mobile data traffic generated by public users can increase significantly, e.g., for making emergency calls, sharing information to friends or relatives. If first responders and general public users share the same network, it is crucial to ensure the flow of critical information (e.g., MC services and emergency calls) no matter how busy the network is. This brings stringent requirements for 5G access control mechanisms to be able to early identify and prioritize access requests from mission critical users, to guarantee that they are accepted and properly served even when the network experiences congestion.

1.5.2. Small Data Transmission

NR supports the RRC_INACTIVE state, and UEs with infrequent (periodic and/or non-periodic) data transmission are generally maintained by the network in the RRC_INACTIVE state. Until NR Rel-16, the RRC_INACTIVE state did not support data transmission. Hence, the UE had to resume the connection (e.g., move to the RRC_CONNECTED state) for any DL (e.g., mobile termination (MT)) and UL (e.g., mobile originating (MO)) data. Connection setup and subsequently release to INACTIVE state happens for each data transmission however small and infrequent the data packets are. This results in unnecessary power consumption and signaling overhead.

A work item for support of small data transmission (SDT) in NR release 17 is approved in RAN #86.

In RAN2 #111-e meeting, where it has been agreed that both 2-step RACH and 4-step RACH will be applied to RACH based uplink small data transmission via Msg3 PUSCH or MsgA PUSCH. To support SDT on Msg3 PUSCH or MsgA PUSCH, the network node needs to be able to identify/differentiate an access request related to SDT over other access requests.

1.5.3. Satellite Communications

Satellite access networks have been playing a complementary role in the communications ecosystem. Despite the wide deployment of terrestrial mobile networks, there are unserved or underserved areas around the globe due to economic rationales. For example, providing coverage in rural or remote areas has been challenging in many countries because the investment cost may not justify the expected revenue. In contrast, a single communication satellite can cover a large geographic area, and, thus, it might be economically appealing to use satellite communications to augment terrestrial networks to provide connectivity in rural and remote areas. In urban areas, high-throughput satellites communications systems may help offload traffic in terrestrial networks. Another potential alternative is to use satellites for backhauling, fostering the rollout of 5G services with potentially reduced costs in rural and remote areas.

The large satellite coverage can also benefit communication scenarios with airborne and maritime platforms (onboard aircrafts or vessels), while being attractive in certain machine-to-machine and telemetry applications. Additionally, satellites are resilient to natural disasters on earth, making satellite communications key for emergency services in case that the terrestrial network infrastructures are degraded. Therefore, if multiple services (e.g., small data transmission (SDT), MC Services, TV broadcast, or SDT services) are supported by satellite communications, it is beneficial for a satellite base station to be able to differentiate different services or UE types at an early stage so that it can optimize its own the admission control and scheduling decisions, or/and better coordinate with the terrestrial network nodes to secure the flow of critical information.

1.5.4. 5G Network Slicing

Network slicing is a concept introduced in 5G to enable service differentiation on a common network infrastructure. Each slice can be a collection of network functionalities or/and resources that are optimized to meet the specific requirement for a service type. For instance, a network can configure different slices for enhanced Mobile Broadband (eMBB) service, vehicle-to-everything (V2X) service, MC service, etc. The current NR standard supports only resource separation of user plane data, not the full separation of control plane resources, meaning that all network slices share the same RACH configuration for UEs in the RRC Idle/Inactive states.

### SUMMARY

Based on the existing NR Rel-15 and Rel-16 4-step RACH procedure, during an initial access phase, the earliest time for a network node to identify a UE type or a service type is in step 3 of the RACH procedure (e.g., after a successful reception of the RRC establishment caused in msg3 transmitted from the UE). In the existing procedures, regardless of subscription type, service type, and/or configured network slice, all UEs in RRC Idle or Inactive states are configured with the same 4-step RACH configuration (e.g., the same PRACH occasions and the same PRACH configuration index, etc.) for transmitting msg1 when performing random access. Therefore, in existing procedures, it is not possible for a network node to differentiate or identify any of the UE type, the service type, and the slice ID by detecting msg1, and a network node cannot prioritize Msg1/Msg2/Msg3 transmissions for certain high priority services or some slices in random access.

In addition, according to the current NR standard (NR Rel-15 and Rel-16), the establishmentCause for all mission critical (MC) UEs will be set to mcs-PriorityAccess, regardless of the priority/role of this MC UE. This implies that a network node cannot further differentiate between different MC UEs/Services in an initial access procedure.

For a 2-step RA procedure in CFRA, the reliability of msgA preamble part and PUSCH part might be quite different due to the PUSCH colliding in 2-step RACH while msg3 PUSCH in 4-step RACH is dynamically scheduled by RAR (for initial transmission) or DCI (for retransmission). In some other aspects, the msgA PUSCH resource used for higher priority may be prioritized so that the msgA PUSCH performance can be assured (e.g., if msgA preamble part cannot be used for UE priority identification).

For some public safety use cases, the priority level of each public safety UE may change dynamically according to the emergency situations. For example, after conducting his/her/its mission, a public safety UE in a first responder group can be moved to a second responder group, which has a relatively lower priority as compared to the first responder group, but its priority is still higher than normal users. Similarly, a public safety UE in a second responder group can be dynamically moved (e.g., by the command center) to a first responder group, which as a relatively higher priority as compared to the second responder group.

For Radio Resource Control (RRC) connected UEs, the priority information is typically known at the network. However, if the priority level or UE capability is dynamically changed in the situations described above, then, the priority information of this UE that is stored at the network side can be outdated. Therefore, a mechanism is needed to enable the network to know the updated UE priority level.

Aspects of the invention may overcome one or more of these problems by a network node using a Contention Free Random Access (CFRA) procedure to obtain the latest UE priority, UE type, UE service priority, UE service type, UE configured network slice, and/or UE capability information. In some aspects, the network node may signal at least two different Msg1/MsgA configurations. In some aspects, different physical random access channel (PRACH) configurations may be mapped to different groups (e.g., for different UE priority levels, different service priority levels, different UE types, different service types, and/or different network slices). In some aspects, a UE may select which PRACH configuration to use for its random-access preamble transmission based on the UE's current group (e.g., based on the UE's current priority, type, service priority, service type, and/or network slice.

Aspects of the invention may pre-configure UEs to different physical random access channel (PRACH) occasions, preamble IDs, or msgA PUSCH (in 2-step RA procedure) resources for different groups (e.g., UE and/or service priorities or types and/or network slices). A UE may select which configuration to use for random-access preamble transmission based on its associated group.

Aspects of the invention may enable a network node to differentiate different UE subscription types, UE service types, and/or network slice identities during a random access procedure.

Aspects of the invention may enables a network node to obtain an updated priority level or capability type of a UE in an RRC connected state. Thus, the network node may be able to adapt its treatment of the UE based on the latest group (e.g., latest priority) information of the UE. The network node may additionally or alternatively be able to optimize the scheduling decisions for the following message transmissions during random access according to the corresponding requirements.

Aspects of the invention may additionally or alternatively be used to enable a finer differentiation between UEs belonging to the same priority category (e.g., high priority level 1 for a first responders group and high priority level 2 for a second responders group, where both groups are associated to a high priority access category.

One aspect of the invention may provide a method performed by a user equipment. The method may include selecting a physical random access channel (PRACH) configuration from a group including at least a first PRACH configuration associated with a first group for contention free random access and a second PRACH configuration associated with a second group for contention free random access. The first and second PRACH configurations may be different. The method may include transmitting a random access preamble in accordance with the selected PRACH configuration as part of a contention free random access procedure.

In some aspects, the method may further include receiving a random access preamble assignment for a contention free random access procedure, and the random access preamble may be transmitted in accordance with the selected PRACH configuration and the random access preamble assignment. In some aspects, the method may further include receiving a physical uplink shared channel (PUSCH) assignment for the contention free random access procedure. In some aspects, the method may further include transmitting a request message in PUSCH with the random access preamble, and the request message may be transmitted in accordance with the PUSCH assignment.

In some aspects, the method may further include receiving a random access response (RAR) to the transmitted random access preamble. In some aspects, the RAR may include a UE identifier assignment, timing advance information, and a contention resolution message. In some aspects, the method may further include, in response to receiving and successfully decoding the RAR, transmitting a request message in physical uplink shared channel (PUSCH).

In some aspects, the method may further include receiving the first PRACH configuration and receiving the second PRACH configuration. In some aspects, the first and second PRACH configurations may be received as part of a system information block.

In some aspects, the group may further include a third PRACH configuration associated with a third group, and the first, second, and third PRACH configurations may be different. In some aspects, the method may further include receiving a system information block including the first, second, and third PRACH configurations.

In some aspects, the first and second PRACH configurations may be different in at least one of the following parameters: valid PRACH occasions, PRACH configuration periodicities, preamble formats, configured preamble indexes per random access occasion, transmitting power, and power ramping step.

In some aspects, the first PRACH configuration may include a first list of PRACH occasions, the second PRACH configuration may include a second list of PRACH occasions, and the first and second lists may be different. In some aspects, the random access preamble may be transmitted in a PRACH occasion of the first list if the selected PRACH configuration is the first PRACH configuration, and the random access preamble is transmitted in a PRACH occasion of the second list if the selected PRACH configuration is the second PRACH configuration. In some aspects, the second list of PRACH occasions may include one or more PRACH occasions masked by a PRACH mask. In some aspects, the first list of PRACH occasions may be associated with a first list of synchronization signals/physical broadcast channel block (SSB) resources, the second list of PRACH occasions is associated with a second list of SSB resources, and the first and second lists of SSB resources are different. In some aspects, the random access preamble may be transmitted with one or more SSB resources in the first list of SSB resources if the selected PRACH configuration is the first PRACH configuration, and the random access preamble may be transmitted with one or more SSB resources in the second list of SSB resources if the selected PRACH configuration is the second PRACH configuration.

In some aspects, the first list of PRACH occasions may be associated with a first list of channel state information-reference signal (CSI-RS) resources, the second list of PRACH occasions may be associated with a second list of CSI-RS resources, and the first and second lists of CSI-RS resources may be different. In some aspects, the random access preamble may be transmitted with one or more CSI-RS resources in the first list of CSI-RS resources if the selected PRACH configuration is the first PRACH configuration, and the random access preamble may be transmitted with one or more CSI-RS resources in the second list of CSI-RS resources if the selected PRACH configuration is the second PRACH configuration. In some aspects, the first and second lists of PRACH occasions may be defined in an information element (IE) for random access ConfigDedicated information element (IE).

In some aspects, the first PRACH configuration may have a first set of preamble indexes per PRACH occasion, the second PRACH configuration may have a second set of preamble indexes per PRACH occasion, and the first and second sets of preamble indexes may not overlap. In some aspects, the first set of preamble indexes may be associated with a first list of synchronization signals/physical broadcast channel block (SSB) resources, the second set of preamble indexes may be associated with a second list of SSB resources, and the first and second lists of SSB resources may be different. In some aspects, the random access preamble may be transmitted with one or more SSB resources in the first list of SSB resources if the selected PRACH configuration is the first PRACH configuration, and the random access preamble may be transmitted with one or more SSB resources in the second list of SSB resources if the selected PRACH configuration is the second PRACH configuration. In some aspects, the first set of preamble indexes may be associated with a first list of channel state information-reference signal (CSI-RS) resources, the second set of preamble indexes may be associated with a second list of CSI-RS resources, and the first and second lists of CSI-RS resources may be different. In some aspects, the random access preamble may be transmitted with one or more CSI-RS resources in the first list of CSI-RS resources if the selected PRACH configuration is the first PRACH configuration, and the random access preamble may be transmitted with one or more CSI-RS resources in the second list of CSI-RS resources if the selected PRACH configuration is the second PRACH configuration. In some aspects, the first and second sets of preamble indexes may be defined in an information element (IE) for random access ConfigDedicated information element (IE).

In some aspects, the first PRACH configuration may include a first physical uplink shared channel (PUSCH) resource configuration, the second PRACH configuration may include a second PUSCH resource configuration, and the first and second PUSCH resource configurations may be different. In some aspects, the method may further include transmitting a request message in PUSCH with the random access preamble, the request message may be transmitted with the first PUSCH resource configuration if the selected PRACH configuration is the first PRACH configuration, and the request message may be transmitted with the second PUSCH resource configuration if the selected PRACH configuration is the second PRACH configuration. In some aspects, the first and second PUSCH resource configurations may be different with respect to: (i) a demodulation reference signal (DMRS) resource for msgA PUSCH including a DMRS port and/or a DMRS sequence, (ii) a time and/or frequency resource for msgA PUSCH, (iii) power control related parameters for msgA PUSCH including a power ramping step size, a power ramping counter, a power offset relative to the preamble received target power, a power scaling factor for scaling an estimated path loss, and/or a transmit power command (TPC), (iv) a listen before talk (LBT) type of msgA PUSCH, (v) a CP extension of msgA PUSCH, (vi) a frequency hopping configuration of msgA PUSCH, (vii) a waveform of msgA PUSCH, (viii) an interlace configuration of msgA PUSCH, and/or (ix) MCS configuration of msgA PUSCH.

In some aspects, the selection may be based on a priority of the UE, a type of the UE, a priority of a service, a type of the service, and/or a network slice of the UE.

In some aspects, the selection may based on a priority of the UE. In some aspects, the first group may be associated with a first priority, the second group may be associated with a second priority, the second priority may be higher than the first priority, the first PRACH configuration may be selected if the UE has the first priority, and the second PRACH configuration may be selected if the UE has the second priority.

In some aspects, the selection may be based on a type of the UE. In some aspects, the second group may be associated with a set of one or more UE types, and the second PRACH configuration may be selected if the type of the UE is within the set of one or more UE types. In some aspects, the type of the UE may be a subscription type. In some aspects, the set of one or more UE types may include a mission critical (MC) UE and/or a multimedia priority UE.

In some aspects, the method may be for establishing a connection with a network node to obtain a service. In some aspects, the service may be an emergency call, a mission critical (MC) service, a multimedia priority service, a mobile broadband (MBB) service, an enhanced mobile broadband (eMBB) service, a vehicle-to-everything (V2X) service, a television broadcast, a small data transmission (SDT) service, and/or an air-to-ground communication (A2G) service.

In some aspects, the selection may be based on a priority of the service. In some aspects, the first group may be associated with a first priority, the second group may be associated with a second priority, the second priority may be higher than the first priority, the first PRACH configuration may be selected if the service has the first priority, and the second PRACH configuration may be selected if the service has the second priority.

In some aspects, the selection may be based on a type of the service. In some aspects, the second group may be associated with a set of one or more service types, and the second PRACH configuration may be selected if the type of the service is within the second set of one or more service types. In some aspects, the type of the service may be one of an emergency call, a mission critical (MC) service, a multimedia priority service, a mobile broadband (MBB) service, an enhanced mobile broadband (eMBB) service, a vehicle-to-everything (V2X) service, a television broadcast, a small data transmission (SDT) service, or an air-to-ground communication (A2G) service. In some aspects, the set of one or more service types may include a mission critical (MC) service.

In some aspects, the selection may be based on a network slice identification (ID). In some aspects, the second group may be associated with a set of one or more network slice IDs, and the second PRACH configuration may be selected if the network slice ID is within the second set of one or more network slice IDs.

Another aspect of the invention may provide a user equipment (UE). The UE may be adapted to select a physical random access channel (PRACH) configuration from a group including at least a first PRACH configuration associated with a first group and a second PRACH configuration associated with a second group. The first and second PRACH configurations may be different. The UE may be adapted to transmit a random access preamble in accordance with the selected PRACH configuration as part of a contention free random access procedure.

Still another aspect of the invention may provide a method performed by a network node. The method may include receiving a random access preamble transmitted by a user equipment (UE) as part of a contention free random access procedure. The method may include determining a physical random access channel (PRACH) configuration that was used by the UE to transmit the random access preamble. The method may include determining that the UE has a first priority, the UE has a first UE type, a service has the first priority, the service has a first service type, and/or a first network slice if the PRACH configuration of the received random access preamble is determined to be a first PRACH configuration. The method may include determining that the UE has a second priority, the UE has a second UE type, the service has the second priority, the service has a second service type, and/or a second network slice if the PRACH configuration of the received random access preamble is determined to be a second PRACH configuration. The first and second PRACH configurations may be different.

In some aspects, the method may further include transmitting a random access preamble assignment for a contention free random access procedure, and the random access preamble may be transmitted in accordance with the random access preamble assignment. In some aspects, the method may further include: transmitting a physical uplink shared channel (PUSCH) assignment for the contention free random access procedure, and receiving a request message transmitted by the UE in PUSCH. The request message may be transmitted in PUSCH with the random access preamble, and the request message may be transmitted in accordance with the PUSCH assignment.

In some aspects, the method may further include, in response to receiving the random access preamble, transmitting a random access response (RAR). In some aspects, the transmitted RAR may include a UE identifier assignment, timing advance information, and a contention resolution message. In some aspects, the method may further include receiving a request message that was conveyed by the UE in physical uplink shared channel (PUSCH).

In some aspects, the method may further include: transmitting the first PRACH configuration and transmitting the second PRACH configuration. In some aspects, the first and second PRACH configurations may be transmitted as part of a system information block.

In some aspects, the method may further include determining that the UE has a third priority, the UE has a third UE type, the service has the third priority, the service has a third service type, and/or a third network slice if the PRACH configuration of the received random access preamble is determined to be a third PRACH configuration. In some aspects, the first, second, and third random access preamble configurations may be different. In some aspects, the method may further include transmitting a system information block including the first, second, and third PRACH configurations.

In some aspects, the first and second PRACH configurations may be different in at least one of the following parameters: valid PRACH occasions, PRACH configuration periodicities, preamble formats, configured preamble indexes per random access occasion, transmitting power, and power ramping step.

In some aspects, the first PRACH configuration may include a first list of PRACH occasions, the second PRACH configuration may include a second list of PRACH occasions, and the first and second lists are different. In some aspects, determining the PRACH configuration of the received random access preamble may include determining whether the received random access preamble was transmitted in a PRACH occasion of the first list or a PRACH occasion of the second list. In some aspects, the second list of PRACH occasions may include one or more PRACH occasions masked by a PRACH mask. In some aspects, the first list of PRACH occasions may be associated with a first list of synchronization signals/physical broadcast channel block (SSB) resources, the second list of PRACH occasions may be associated with a second list of SSB resources, and the first and second lists of SSB resources may be different. In some aspects, determining the PRACH configuration of the received random access preamble may include determining whether the received random access preamble was transmitted with one or more SSB resources in the first list of SSB resources or one or more SSB resources in the second list of SSB resources.

In some aspects, the first list of PRACH occasions may be associated with a first list of channel state information-reference signal (CSI-RS) resources, the second list of PRACH occasions may be associated with a second list of CSI-RS resources, and the first and second lists of CSI-RS resources may be different. In some aspects, determining the PRACH configuration of the received random access preamble may include determining whether the received random access preamble was transmitted with one or more CSI-RS resources in the first list of CSI-RS resources or one or more CSI-RS resources in the second list of CSI-RS resources. In some aspects, the first and second lists of PRACH occasions may be defined in an information element (IE) for random access ConfigDedicated information element (IE).

In some aspects, the first PRACH configuration may have a first set of preamble indexes per PRACH occasion, the second PRACH configuration may have a second set of preamble indexes per PRACH occasion, the first and second sets of preamble indexes may not overlap, and determining the PRACH configuration of the received random access preamble may include determining whether a preamble index of the received random access preamble is in the first set or the second set. In some aspects, the first set of preamble indexes may be associated with a first list of synchronization signals/physical broadcast channel block (SSB) resources, the second set of preamble indexes may be associated with a second list of SSB resources, and the first and second lists of SSB resources may be different. In some aspects, determining the PRACH configuration of the received random access preamble may include determining whether the received random access preamble was transmitted with one or more SSB resources in the first list of SSB resources or one or more SSB resources in the second list of SSB resources. In some aspects, the first set of preamble indexes may be associated with a first list of channel state information-reference signal (CSI-RS) resources, the second set of preamble indexes may be associated with a second list of CSI-RS resources, and the first and second lists of CSI-RS resources may be different. In some aspects, determining the PRACH configuration of the received random access preamble may include determining whether the received random access preamble was transmitted with one or more CSI-RS resources in the first list of CSI-RS resources or one or more CSI-RS resources in the second list of CSI-RS resources. In some aspects, the first and second sets of preamble indexes may be defined in an information element (IE) for random access ConfigDedicated information element (IE).

In some aspects, the first PRACH configuration may include a first physical uplink shared channel (PUSCH) resource configuration, the second PRACH configuration may include a second PUSCH resource configuration, and the first and second PUSCH resource configurations may be different. In some aspects, the method may further include receiving a request message transmitted by the UE in PUSCH, the request message may be transmitted in PUSCH with the random access preamble, and determining the PRACH configuration of the received random access preamble may include determining whether the received request message was transmitted with the first PUSCH resource configuration or the second PUSCH resource configuration. In some aspects, the first and second PUSCH resource configurations may be different with respect to: (i) a demodulation reference signal (DMRS) resource for msgA PUSCH including a DMRS port and/or a DMRS sequence, (ii) a time and/or frequency resource for msgA PUSCH, (iii) power control related parameters for msgA PUSCH including a power ramping step size, a power ramping counter, a power offset relative to the preamble received target power, a power scaling factor for scaling an estimated path loss, and/or a transmit power command (TPC), (iv) a listen before talk (LBT) type of msgA PUSCH, (v) a CP extension of msgA PUSCH, (vi) a frequency hopping configuration of msgA PUSCH, (vii) a waveform of msgA PUSCH, (viii) an interlace configuration of msgA PUSCH, and/or (ix) MCS configuration of msgA PUSCH.

In some aspects, the UE may be attempting to establish a connection with the network node to obtain the service. In some aspects, the UE may be determined to have the first priority if the PRACH configuration of the received random access preamble is determined to be a first PRACH configuration, the UE may be determined to have the second priority if the PRACH configuration of the received random access preamble is determined to be a second PRACH configuration, and the second priority may be higher than the first priority.

In some aspects, the UE may be determined to have the first UE type if the PRACH configuration of the received random access preamble is determined to be a first PRACH configuration, the UE may be determined to have the second UE type if the PRACH configuration of the received random access preamble is determined to be a second PRACH configuration, and the first and second UE types may be different. In some aspects, the first and second UE types may be subscription types. In some aspects, the second UE type may be a mission critical (MC) UE or a multimedia priority UE. In some aspects, the second UE type may be one of a set of one or more UE types. In some aspects, the set of one or more UE types may include a mission critical (MC) UE and/or a multimedia priority UE.

In some aspects, the service may be determined to have the first priority if the PRACH configuration of the received random access preamble is determined to be a first PRACH configuration, the service may be determined to have the second priority if the PRACH configuration of the received random access preamble is determined to be a second PRACH configuration, and the second priority may be higher than the first priority.

In some aspects, the service may be determined to have the first service type if the PRACH configuration of the received random access preamble is determined to be a first PRACH configuration, the service may be determined to have the second service type if the PRACH configuration of the received random access preamble is determined to be a second PRACH configuration, and the first and second service types may be different. In some aspects, the second service type may be a mission critical (MC) service. In some aspects, the second service type may be one of a set of one or more service types. In some aspects, the set of one or more service types may include a mission critical (MC) service.

In some aspects, the first network slice may be determined if the PRACH configuration of the received random access preamble is determined to be a first PRACH configuration, the second network slice may be determined if the PRACH configuration of the received random access preamble is determined to be a second PRACH configuration, and the first and second network slices may be different. In some aspects, the second network slice may be one of a set of one or more network slices.

In some aspects, the service may be an emergency call, a mission critical (MC) service, a multimedia priority service, a mobile broadband (MBB) service, an enhanced mobile broadband (eMBB) service, a vehicle-to-everything (V2X) service, a television broadcast, a small data transmission (SDT) service, or an air-to-ground communication (A2G) service.

Another aspect of the invention may provide a network node. The network node may be adapted to receive a random access preamble transmitted by a user equipment (UE) as part of a contention free random access procedure. The network node may be adapted to determine a physical random access channel (PRACH) configuration that was used by the UE to transmit the random access preamble. The network node may be adapted to determine that the UE has a first priority, the UE has a first UE type, a service has the first priority, the service has a first service type, and/or a first network slice if the PRACH configuration of the received random access preamble is determined to be a first PRACH configuration. The network node may be adapted to determine that the UE has a second priority, the UE has a second UE type, the service has the second priority, the service has a second service type, and/or a second network slice if the PRACH configuration of the received random access preamble is determined to be a second PRACH configuration. The first and second PRACH configurations may be different.

Yet another aspect of the invention may provide a computer program including instructions for adapting an apparatus to perform the method of any one of the aspects above. Still another aspect of the invention may provide a carrier containing the computer program, and the carrier may be one of an electronic signal, optical signal, radio signal, or compute readable storage medium.

Yet another aspect of the invention may provide an apparatus. The apparatus may include processing circuitry and a memory. The memory may contain instructions executable by said processing circuitry, whereby said apparatus is operative to perform the method of any one of the aspects above.

### BRIEF DESCRIPTION OF THE DRAWINGS

The accompanying drawings, which are incorporated herein and form part of the specification, illustrate various embodiments.

FIG. 1 illustrates a four-step random access procedure for initial access.

FIG. 2 illustrates a two-step random access procedure for initial access.

FIG. 3A illustrates a 4-step random access type contention free random access.

FIG. 3B illustrates a 4-step random access type contention free random access.

FIG. 4 illustrates a PRACH configuration in NR.

FIG. 5 illustrates an example of one SSB per PRACH occasion.

FIG. 6 illustrates an example with 2 SSBs per PRACH occasion.

FIG. 7 illustrates the mapping between SSB and random-access preambles.

FIG. 8 illustrates of the associated preambles for CBRA and CFRA per SSB per PRACH occasion.

FIG. 9 illustrates the associated preambles for CBRA and CFRA per SSB per PRACH occasion, when Random Access Preambles group B is configured.

FIG. 10 illustrates the associated preambles for CBRA and CFRA per SSB per PRACH occasion, when random access channel occasions (ROs) for 2-step RACH and 4-step RACH are shared.

FIG. 11A illustrates a RACH-ConfigDedicated information element for 4-step random access type according to some aspects.

FIG. 11B illustrates a RACH-ConfigDedicated information element for 2-step random access type according to some aspects.

FIG. 12 illustrates an information element with a separate set of PUSCH occasion configuration for CFRA with a 2-step RA type according to some aspects.

FIG. 13 illustrates a RACH-ConfigDedicated information element with a separate set of SSB resource list or CSI-RS resource list for high priority UEs to do CFRA according to some aspects.

FIG. 14 illustrates a separate preamble ID ra-PreambleIndexHighPrio in CFRA-SSB-Resource and/or CFRA-CSIRS-Resource carried by a RACH-ConfigDedicated information element for higher priority UEs to do CFRA according to some aspects.

FIG. 15 is a flow chart illustrating a process performed by a user equipment according to some aspects.

FIG. 16 is a block diagram of a user equipment according to some aspects.

FIG. 17 is a block diagram of a user equipment according to some aspects.

FIG. 18 is a flow chart illustrating a process performed by a network node according to some aspects.

FIG. 19 is a block diagram of a network node according to some aspects.

FIG. 20 is a block diagram of a network node according to some aspects.

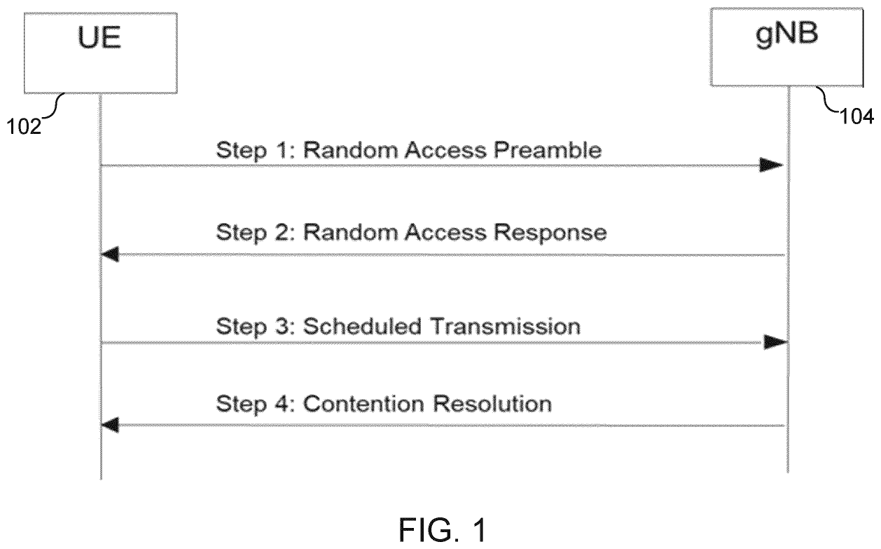

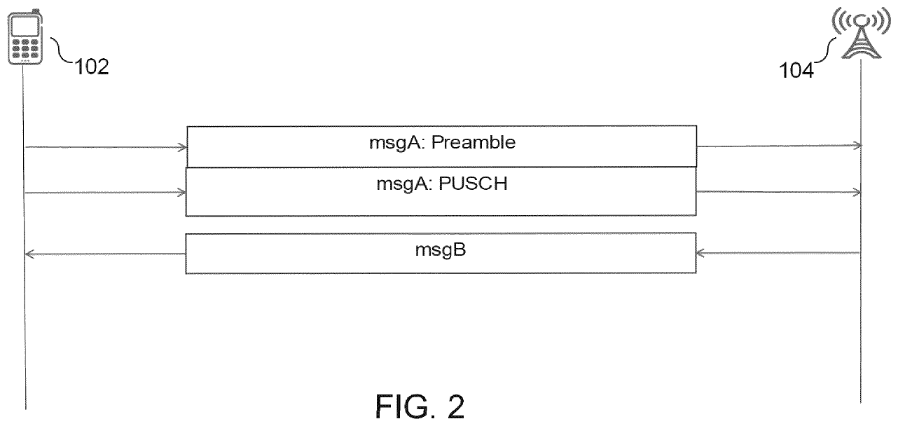

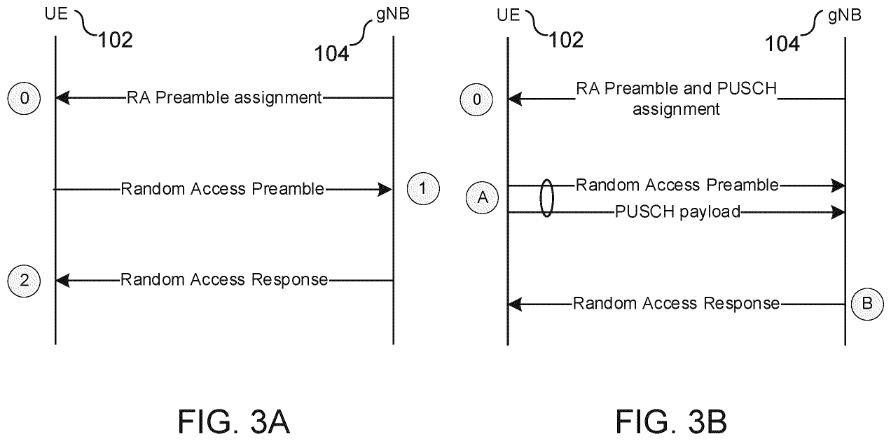

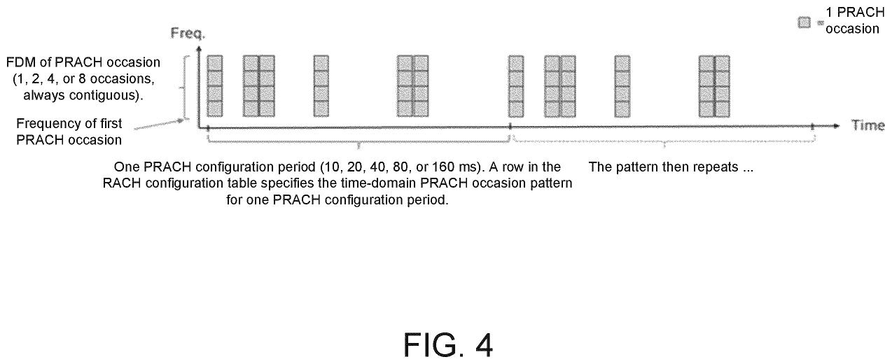

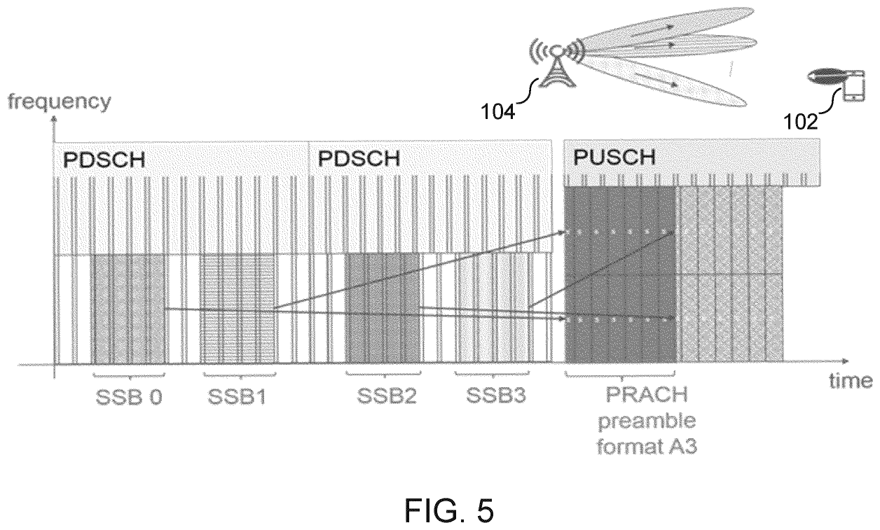

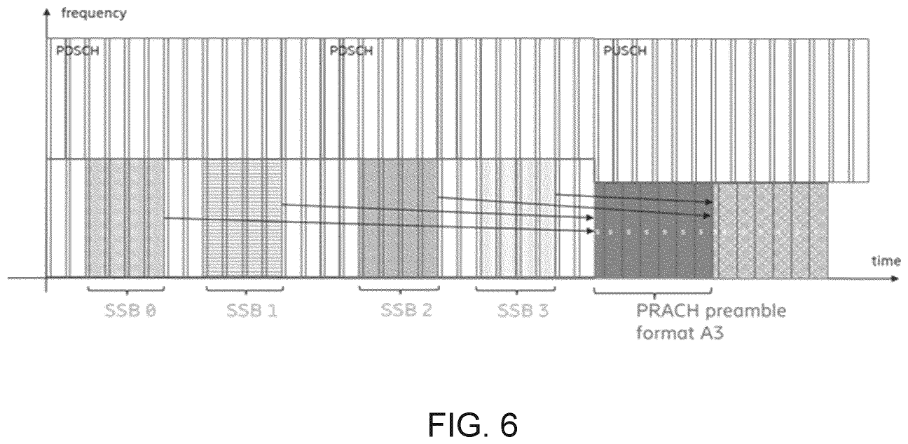

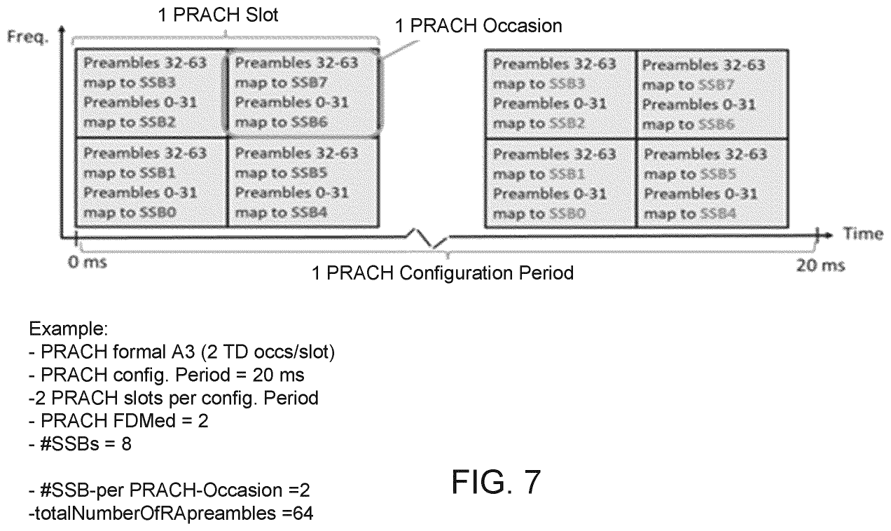

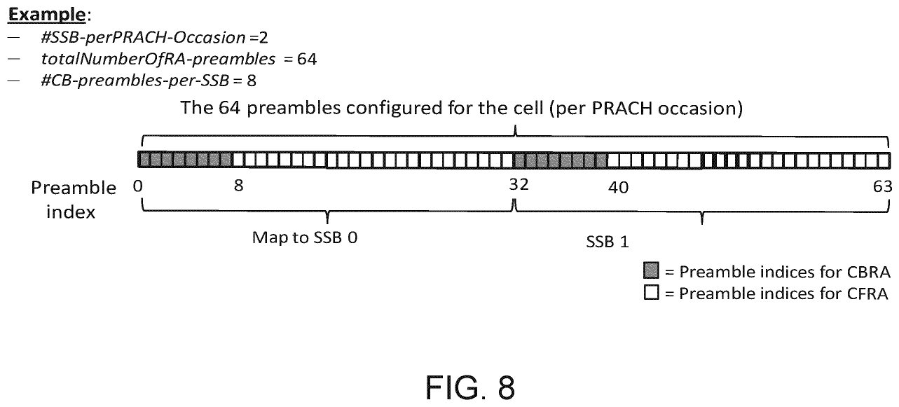

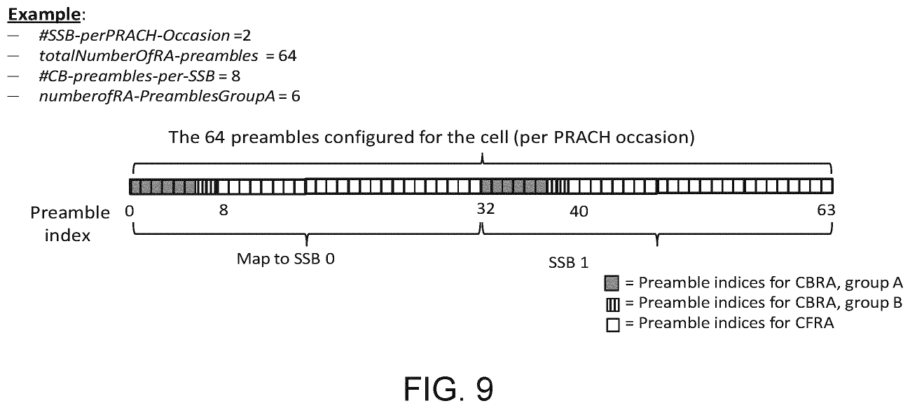

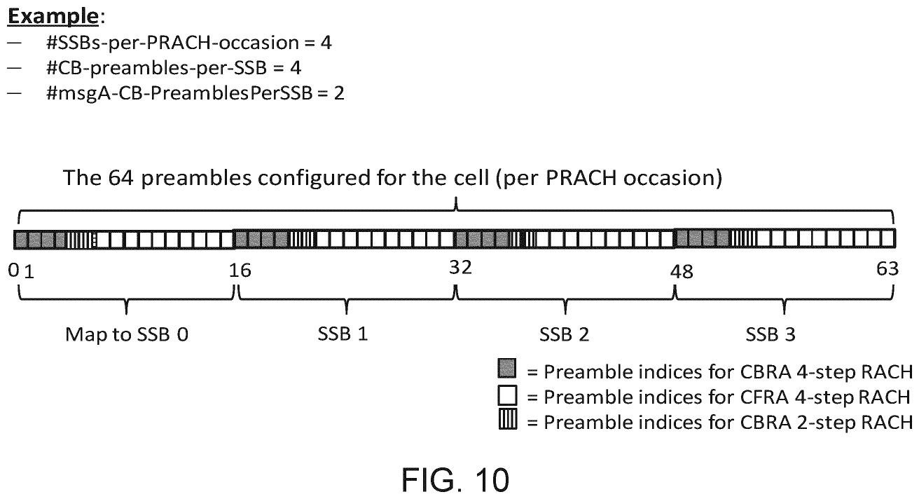

### DETAILED DESCRIPTION

### 2. Terminology

In this application, the term “node” can be a network node or a user equipment (UE). Examples of network nodes include, but are not limited to, a NodeB, a base station (BS), a multi-standard radio (MSR) radio node such as a MSR BS, an eNodeB, a gNodeB, a Master eNB (MeNB), a Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, remote radio unit (RRU), remote radio head (RRH), nodes in distributed antenna system (DAS), core network node (e.g. MSC, MME, etc.), O&M, OSS, SON, positioning node (e.g. E-SMLC).

In this application, the term “user equipment” or “UE” is a non-limiting term that refers to any type of wireless device communicating with a network node and/or with another UE in a cellular or mobile communication system. Examples of UEs include, but are not limited to, a target device, a device to device (D2D) UE, a vehicular to vehicular (V2V), a machine type UE, an machine type communication (MTC) UE, a UE capable of machine to machine (M2M) communication, a PDA, a Tablet, a mobile terminal(s), a smart phone, laptop embedded equipment (LEE), laptop mounted equipment (LME), and USB dongles.

In this application, the terms “radio network node,” “network node,” and “NW node” is generic terminology that refers to any kind of network node including but not limited to a base station, a radio base station, a base transceiver station, a base station controller, a network controller, an evolved Node B (eNB), a Node B, a gNodeB (gNB), a relay node, an access point (AP), a radio access point, a Remote Radio Unit (RRU), a Remote Radio Head (RRH), a Central Unit (e.g. in a gNB), a Distributed Unit (e.g. in a gNB), a Baseband Unit, a Centralized Baseband, and a C-RAN.

In this application, the term “radio access technology” or “RAT” may refer to any RAT including, for example and without limitation, UTRA, E-UTRA, narrow band internet of things (NB-IoT), WiFi, Bluetooth, next generation RAT, New Radio (NR), 4G, and 5G. Any of the equipment denoted by the terms “node,” “network node,” or “radio network node” may be capable of supporting a single or multiple RATs.

### 3. Aspects

In some aspects, a network node 104 may configure different physical random access channel (PRACH) configurations and/or different physical uplink shared channel (PUSCH) configurations for different groups. In some aspects, the groups may be different UE and/or service groups that are associated to different priorities for contention free random access (CFRA) procedure. In some aspects, the groups may be network slice groups. In some aspects, a UE 102 may select which configuration to use for random-access preamble transmission based on its current associated group (e.g., priority group). In some aspects, by detection of the random-access preamble transmitted in a PRACH occasion from a UE 102, the network node 104 can identify the UE priority, UE type, service priority, service type, and/or configured network slice. In some aspects, based on the identified UE priority, UE type, service priority, service type, and/or configured network slice ID, the UE 102 may make an early decision on differentiated admission control and/or traffic steering for this UE 102.

In some aspects, UEs 102 may be pre-configured to different groups depending on the UE priority and/or type, the service priority and/or type, and/or a configured network slices. For example, in some aspects, different groups may be defined based on the UE Access Identity numbers or/and Access Categories. For another example, different groups may be defined based on the network slice IDs. For yet another example, different groups may be defined based on the service type (e.g., Mobile Broadband (MBB), Mission Critical Services, small data transmission (SDT), air-to-ground communications (A2G), etc.).

In some aspects, in addition to the legacy PRACH configuration for 4-step random access procedure in NR Rel-15 and for 2-step random access procedure in NR-Rel-16, at least one additional PRACH configuration may be added in common or dedicated radio resource control (RRC) signaling, where the legacy and the newly added PRACH configurations are associated to different groups. In some aspects, these different groups may be defined based on the UE/service priority, UE/service type, and/or network slice IDs. In some aspects, if only one additional PRACH configuration is added, then the added PRACH configuration may be associated with a UE/Service group that has a higher priority. In some aspects, if two or more additional PRACH configurations are added, then the legacy PRACH configuration may be associated with the lowest priority group. In some aspects, the legacy and the one or more newly added PRACH configurations may be differentiated in at least one of the following parameters: valid PRACH occasions, PRACH periodicities, preamble formats, configured preamble indexes per PRACH occasion, transmitting power, and power ramping step.

Different aspects of methods, apparatuses (e.g., UEs 102 and/or network nodes 104), and systems for configuring an additional PRACH configuration (e.g., in a system information block 1 (SIB1)) are described below. Any of these aspects may be extended for the cases where two or more PRACH configurations are added. The aspects and examples below focus on the case of defining different PRACH configurations based on the UE/service priority level. However, the methods may be used for defining different PRACH configurations based on the UE/service type, network slice IDs, etc.

3.1 Differentiated PRACH Occasions and/or PUSCH Occasions

In some aspects, PRACH occasions for one or more newly added PRACH configurations may be configured separately from the PRACH occasions configured by the legacy configuration. In some aspects, for CFRA with 2-step RA type, the PUSCH occasions may be separately included for a particular group (e.g., high priority UEs), or the masked ROs by a PRACH mask can be used for the particular group (e.g., higher priority UEs). In some aspects, as described below, the different PRACH occasions and/or PUSCH occasions may be associated with different priorities (e.g., different UE priorities or different service priorities). However, this is not required, and, in some alternative aspects, the different PRACH occasions and/or PUSCH occasions may be used be associated with different types (e.g., different UE types or different service types) or different network slices.

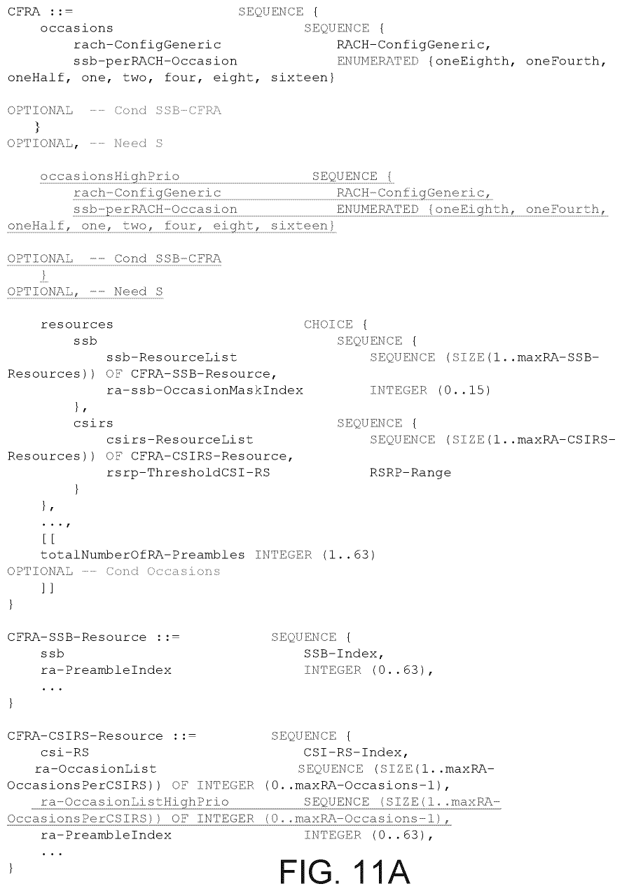

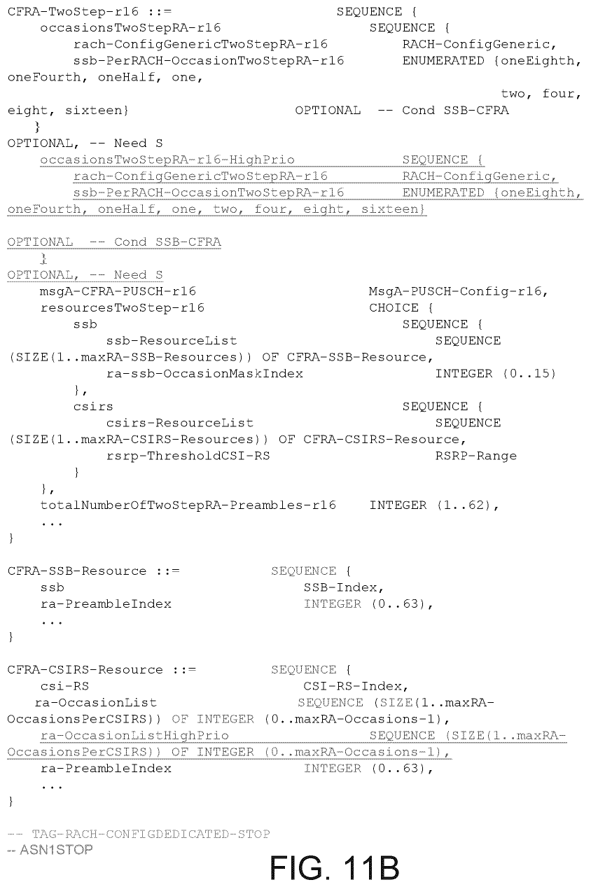

In some aspects, for CFRA, some dedicated signaling for configuring RO resources may be provided for higher priority RA in order to differentiate with normal priority RA. In some aspects, for CFRA, a separate RO list may be configured from high layer for higher priority UEs, where the RACH occasion (RO) list may be associated to a list of synchronization signals/physical broadcast channel block (SSB) resources or channel state information-reference signal (CSI-RS) resources. In some aspects, for CFRA with 4-step RA type, a set of ROs may be defined in RACH-ConfigDedicated information element (IE) for high priority UEs. FIG. 11A illustrates an example of a RACH-ConfigDedicated IE for 4-step random access type with a set of ROs for high priority UEs shown with underlining. In some aspects, for CFRA with 2-step RA type, a separate set of ROs may be defined in RACH-ConfigDedicated IE for high priority UEs. FIG. 11B illustrates a RACH-ConfigDedicated IE for 2-step random access type with a set of ROs for high priority UEs shown with underlining.

In some aspects, for CFRA with 2-step RA type, a separate MsgA PUSCH resource configuration may be configured from high layer for higher priority UEs. In some aspects, the MsgA PUSCH resource may be: (i) a demodulation reference signal (DMRS) resource for msgA PUSCH including a DMRS port and/or a DMRS sequence, (ii) a time and/or frequency resource for msgA PUSCH, (iii) power control related parameters for msgA PUSCH including a power ramping step size, a power ramping counter, a power offset relative to the preamble received target power, a power scaling factor for scaling an estimated path loss, and/or a transmit power command (TPC), (iv) a listen before talk (LBT) type of msgA PUSCH, (v) a cyclic prefix (CP) extension of msgA PUSCH, (vi) a frequency hopping configuration of msgA PUSCH, (vii) a waveform of msgA PUSCH, (viii) an interlace configuration of msgA PUSCH, and/or (ix) a modulation coding scheme (MCS) configuration of msgA PUSCH.

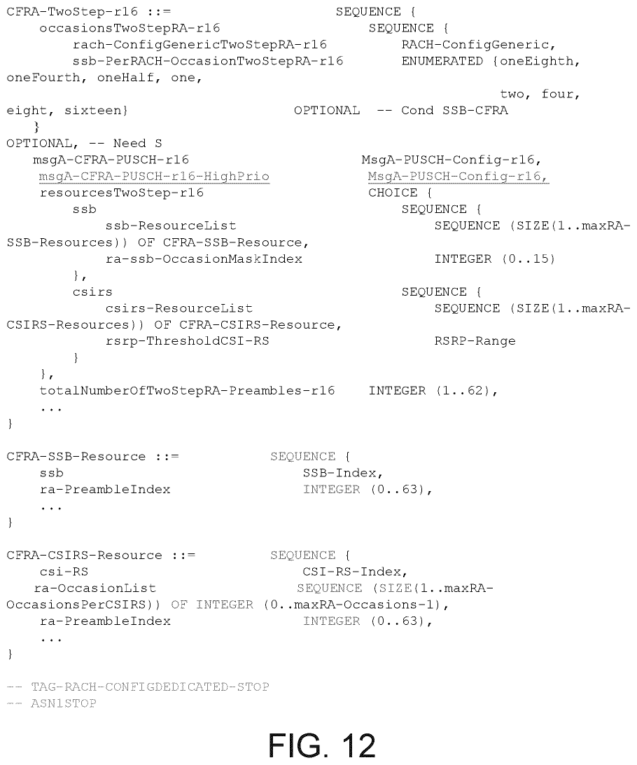

FIG. 12 illustrates an example of an information element for 2-step RA type with a separate set of PUSCH occasion configuration shown with underlining. As another example, for CFRA with 2-step RA type, one of the PUSCH occasion with a DMRS resource may be provided to the UE 102 with a higher priority via radio resource control (RRC) signaling or via a predetermined value.

In some aspects, in CFRA, a PRACH mask may invalidate some of the ROs so that they will not be used for normal RA, and these ROs may be used for higher priority RA. In some aspects, for CFRA, ROs masked by ra-ssb-OccasionMaskIndex may be used by high priority UEs, where the ROs masked are associated to a list of SSB resources configured.

3.2 Differentiated Preamble Indexes Per PRACH Occasion

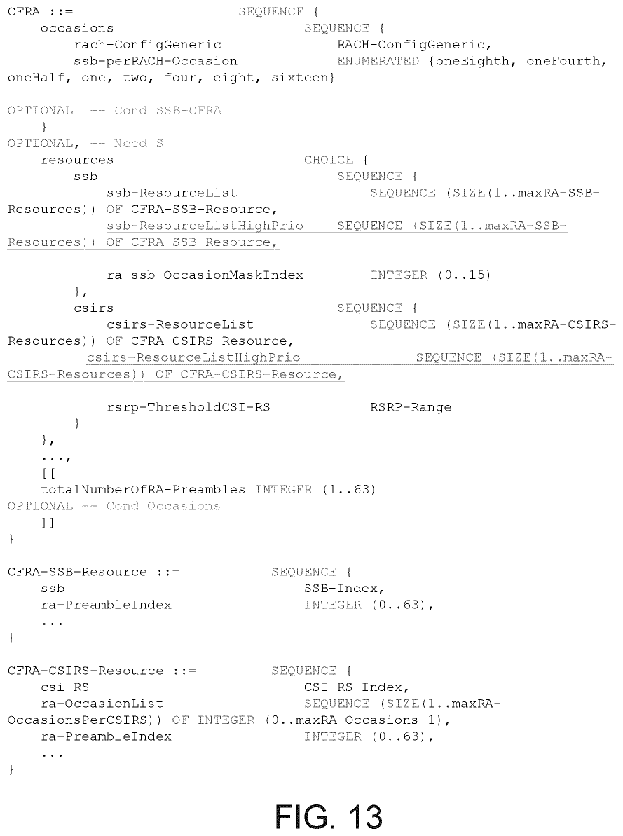

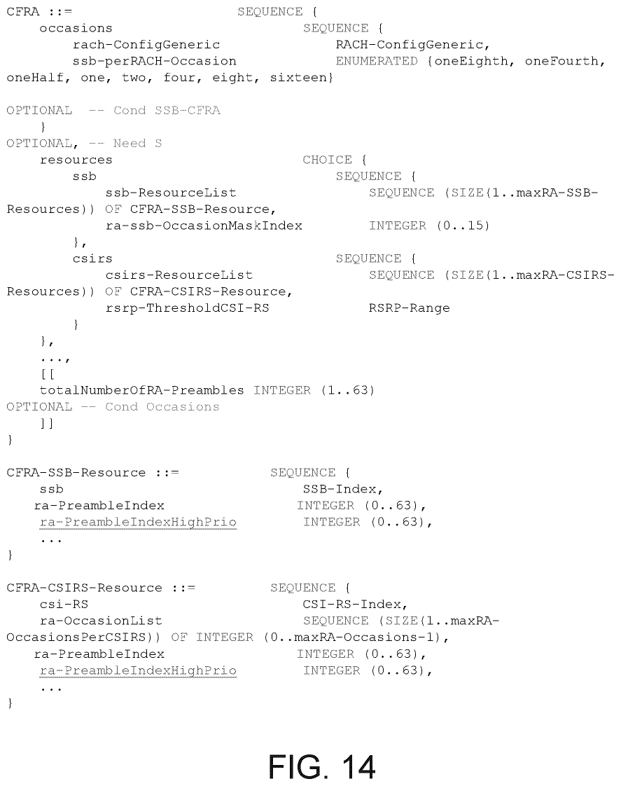

In some aspects, different groups (e.g., UE priority groups) may share the same configuration of valid PRACH occasions, but the different groups may be configured with non-overlapping sets of preamble indexes per PRACH occasion. In some aspects, for CFRA, a separate preamble list and/or SSB resource list and/or CSI-RS resource list may be configured from high layer for higher priority UEs. In some aspects, a separate set of SSB resource list or CSI-RS resource list may be provided in in RACH-ConfigDedicated for higher priority UEs to do CFRA. FIG. 13 illustrates an example of a RACH-ConfigDedicated information element with a separate set of SSB resource list or CSI-RS resource list for high priority UEs shown with underlining. In some alternative aspects, a separate preamble ID ra-PreambleIndexHighPrio may be provided in CFRA-SSB-Resource and/or CFRA-CSIRS-Resource carried by the RACH-ConfigDedicated IE for higher priority UEs to do CFRA. FIG. 14 illustrates an example of a separate preamble ID ra-PreambleIndexHighPrio in CFRA-SSB-Resource and/or CFRA-CSIRS-Resource carried by a RACH-ConfigDedicated information element for higher priority UEs shown with underlining.

In some aspects, the non-overlapping sets of preamble indexes per PRACH occasion may be associated with different priorities (e.g., different UE priorities or different service priorities). However, this is not required, and, in some alternative aspects, the non-overlapping sets of preamble indexes per PRACH occasion may be used be associated with different types (e.g., different UE types or different service types) or different network slices.

3.3 Flowcharts

In some aspects, for a 2-step random access procedure and/or a 4-step random access procedure, a network node 104 may configure different random-access preamble configurations (e.g., PRACH occasions, PUSCH occasions, and/or preamble indexes) for different UE/service groups that are associated to different priorities, different service types, or/and different network slice IDs. In some aspects, a UE 102 may select which configuration to use for the random-access preamble transmission based on the associated group of its access request.

In some aspects, in 2-step random access procedure, a network node 104 may configure different msgA PUSCH resources for different groups based on UE/Service priority, UE/service type, or/and network slice ID. In some aspects, a higher priority UE 102 may then select the separate msgA PUSCH resource so that a more reliable msgA PUSCH can be used to inform the network node 104 of the UE priority.

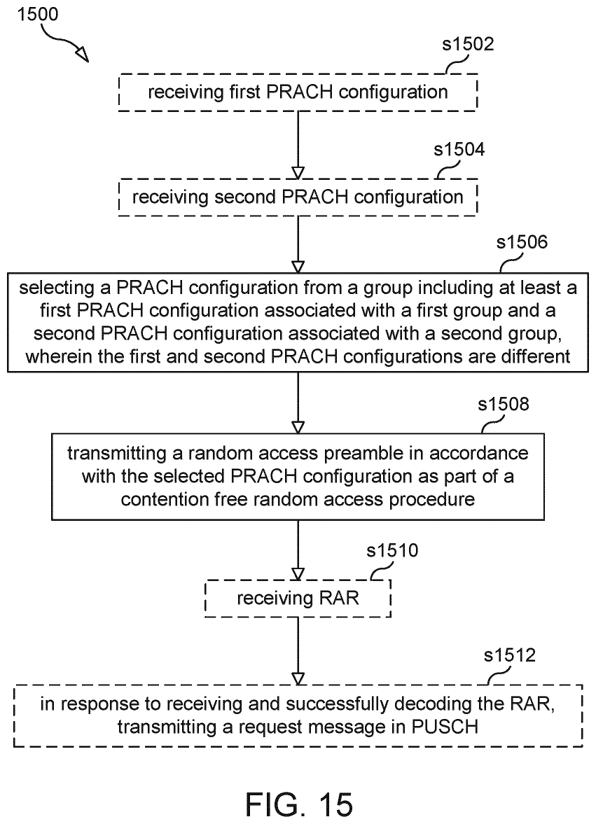

FIG. 15 illustrates a process 1500 performed by a user equipment (UE) 102 according to some aspects. In some aspects, the process 1500 may include optional steps 1502 and 1504 in which the UE 102 receives first and second physical random access channel (PRACH) configurations, respectively. In some aspects, the first and second PRACH configurations may be received as part of a system information block (e.g., SIB1).

In some aspects, the process 1500 may include a step 1506 in which the UE 102 selects a physical random access channel (PRACH) configuration from a group including at least a first PRACH configuration associated with a first group and a second PRACH configuration associated with a second group. In some aspects, the first and second PRACH configurations may be different. In some aspects, the first and second PRACH configurations may be different in at least one of the following parameters: valid PRACH occasions, PRACH configuration periodicities, preamble formats, configured preamble indexes per random access occasion, transmitting power, and power ramping step.

In some aspects, the group may further include a third PRACH configuration associated with a third group. In some aspects, the first, second, and third PRACH configurations may be different. In some aspects, the first, second, and third PRACH configurations may be received in a system information block (e.g., SIB1).

In some aspects, the selection in step 1506 may be based on a priority of the UE 102, a type of the UE 102, a priority of a service, a type of the service, and/or a network slice.

In some aspects, the selection in step 1506 may be based on a priority of the UE 102. In some aspects (e.g., some selection based on UE priority aspects), the first group may be associated with a first priority, the second group may be associated with a second priority, the second priority may be higher than the first priority, the first PRACH may be selected in step 1506 if the UE has the first priority, and the second PRACH may be selected in step 1506 if the UE has the second priority.

In some aspects, the selection in step 1506 may be based on a type of the UE 102. In some aspects (e.g., some selection based on UE type aspects), the second group may be associated with a set of one or more UE types, and the second PRACH may be selected in step 1506 if the type of the UE 102 is within the set of one or more UE types. In some aspects, the set of one or more UE types may include, for example and without limitation, a mission critical (MC) UE and/or a multimedia priority UE. In some aspects, the first group may be associated with a different set of one or more UE types, and the first PRACH may be selected in step 1506 if the type of the UE 102 is within the different set of one or more UE types. In some aspects, the type of the UE may be a subscription type.

In some aspects, the process 1500 may be for establishing a connection with the network node 104 to obtain a service. In some aspects, the service may be, for example and without limitation, an emergency call, a mission critical (MC) service, a multimedia priority service, a mobile broadband (MBB) service, an enhanced mobile broadband (eMBB) service, a vehicle-to-everything (V2X) service, a television broadcast, a small data transmission (SDT) service, and/or an air-to-ground communication (A2G) service.

In some aspects, the selection in step 1506 may be based on a priority of the service. In some aspects (e.g., some selection based on service priority aspects), the first group may be associated with a first priority, the second group may be associated with a second priority, the second priority may be higher than the first priority, the first PRACH may be selected in step 1506 if the service has the first priority, and the second PRACH may be selected in step 1506 if the service has the second priority.

In some aspects, the selection in step 1506 may be based on a type of the service. In some aspects (e.g., some selection based on service type aspects), the second group may be associated with a set of one or more service types, and the second PRACH may be selected if the type of the service is within the second set of one or more service types. In some aspects, the set of one or more service types may include, for example and without limitation, an MC service. In some aspects (e.g., some selection based on service type aspects), the first group may be associated with a different set of one or more service types, and the first PRACH may be selected in step 1506 if the type of the service is within the different set of one or more service types. In some aspects, the type of the service may be one of an emergency call, an MC service, a multimedia priority service, a MBB service, an eMBB service, a V2X service, a television broadcast, an SDT service, or an A2G service.

In some aspects, the selection in step 1506 may be based on a network slice identification (ID). In some aspects (e.g., some selection based on network slice aspects), the second group may be associated with a set of one or more network slice IDs, and the second PRACH is selected in step 1506 if the network slice ID is within the second set of one or more network slice IDs. In some aspects (e.g., some selection based on network slice aspects), the first group may be associated with a different set of one or more network slice IDs, and the second PRACH may be selected in step 1506 if the network slice ID is within the different set of one or more network slice IDs.

In some aspects, the process 1500 may include a step 1508 in which the UE 102 transmits a random access preamble in accordance with the selected PRACH configuration as part of a contention free random access procedure. In some aspects, the process 1500 may further include receiving a random access preamble assignment for a contention free random access procedure, and the random access preamble may be transmitted in step 1508 in accordance with the selected PRACH configuration and the random access preamble assignment. In some aspects (e.g., 2-step random access procedure aspects), the process 1500 may further include receiving a physical uplink shared channel (PUSCH) assignment for the contention free random access procedure. In some aspects (e.g., 2-step random access procedure aspects), the step 1508 may include the UE 102 transmitting a request message in physical uplink shared channel (PUSCH) with the random access preamble. In some aspects, the request message may be transmitted in accordance with the PUSCH assignment.

In some aspects, the process 1500 may further include an optional step 1510 in which the UE 102 receives a random access response (RAR) to the transmitted random access preamble. In some aspects (e.g., 2-step random access procedure aspects), the RAR may include a UE identifier assignment, timing advance information, and a contention resolution message.

In some aspects (e.g., 4-step random access procedure aspects), the process 1500 may further include an optional step 1512 in which the UE 102, in response to receiving and successfully decoding the RAR, transmits a request message (e.g., for requesting terminal identification and radio resource control (RRC) connection establishment) in physical uplink shared channel (PUSCH).

In some aspects, the first PRACH configuration may include a first list of PRACH occasions, the second PRACH configuration may include a second list of PRACH occasions, and the first and second lists may be different. In some aspects, the random access preamble may be transmitted in step 1508 in a PRACH occasion of the first list if the selected PRACH configuration is the first PRACH configuration, and the random access preamble is transmitted in step 1508 in a PRACH occasion of the second list if the selected PRACH configuration is the second PRACH configuration. In some aspects, the second list of PRACH occasions may include one or more PRACH occasions masked by a PRACH mask. In some aspects, the first list of PRACH occasions may be associated with a first list of synchronization signals/physical broadcast channel block (SSB) resources, the second list of PRACH occasions is associated with a second list of SSB resources, and the first and second lists of SSB resources are different. In some aspects, the random access preamble may be transmitted in step 1508 with one or more SSB resources in the first list of SSB resources if the selected PRACH configuration is the first PRACH configuration, and the random access preamble may be transmitted in step 1508 with one or more SSB resources in the second list of SSB resources if the selected PRACH configuration is the second PRACH configuration.

In some aspects, the first list of PRACH occasions may be associated with a first list of channel state information-reference signal (CSI-RS) resources, the second list of PRACH occasions may be associated with a second list of CSI-RS resources, and the first and second lists of CSI-RS resources may be different. In some aspects, the random access preamble may be transmitted in step 1508 with one or more CSI-RS resources in the first list of CSI-RS resources if the selected PRACH configuration is the first PRACH configuration, and the random access preamble may be transmitted in step 1508 with one or more CSI-RS resources in the second list of CSI-RS resources if the selected PRACH configuration is the second PRACH configuration. In some aspects, the first and second lists of PRACH occasions may be defined in an information element (IE) for random access ConfigDedicated information element (IE).

In some aspects, the first PRACH configuration may have a first set of preamble indexes per PRACH occasion, the second PRACH configuration may have a second set of preamble indexes per PRACH occasion, and the first and second sets of preamble indexes may not overlap. In some aspects, the first set of preamble indexes may be associated with a first list of synchronization signals/physical broadcast channel block (SSB) resources, the second set of preamble indexes may be associated with a second list of SSB resources, and the first and second lists of SSB resources may be different. In some aspects, the random access preamble may be transmitted in step 1508 with one or more SSB resources in the first list of SSB resources if the selected PRACH configuration is the first PRACH configuration, and the random access preamble may be transmitted with one or more SSB resources in the second list of SSB resources if the selected PRACH configuration is the second PRACH configuration. In some aspects, the first set of preamble indexes may be associated with a first list of channel state information-reference signal (CSI-RS) resources, the second set of preamble indexes may be associated with a second list of CSI-RS resources, and the first and second lists of CSI-RS resources may be different. In some aspects, the random access preamble may be transmitted in step 1508 with one or more CSI-RS resources in the first list of CSI-RS resources if the selected PRACH configuration is the first PRACH configuration, and the random access preamble may be transmitted in step 1508 with one or more CSI-RS resources in the second list of CSI-RS resources if the selected PRACH configuration is the second PRACH configuration. In some aspects, the first and second sets of preamble indexes may be defined in an information element (IE) for random access ConfigDedicated information element (IE).

In some aspects, the first PRACH configuration may include a first physical uplink shared channel (PUSCH) resource configuration, the second PRACH configuration may include a second PUSCH resource configuration, and the first and second PUSCH resource configurations may be different. In some aspects, the step 1508 may further include transmitting a request message in PUSCH with the random access preamble, the request message may be transmitted with the first PUSCH resource configuration if the selected PRACH configuration is the first PRACH configuration, and the request message may be transmitted with the second PUSCH resource configuration if the selected PRACH configuration is the second PRACH configuration. In some aspects, the first and second PUSCH resource configurations may be different with respect to: (i) a demodulation reference signal (DMRS) resource for msgA PUSCH including a DMRS port and/or a DMRS sequence, (ii) a time and/or frequency resource for msgA PUSCH, (iii) power control related parameters for msgA PUSCH including a power ramping step size, a power ramping counter, a power offset relative to the preamble received target power, a power scaling factor for scaling an estimated path loss, and/or a transmit power command (TPC), (iv) a listen before talk (LBT) type of msgA PUSCH, (v) a CP extension of msgA PUSCH, (vi) a frequency hopping configuration of msgA PUSCH, (vii) a waveform of msgA PUSCH, (viii) an interlace configuration of msgA PUSCH, and/or (ix) MCS configuration of msgA PUSCH.

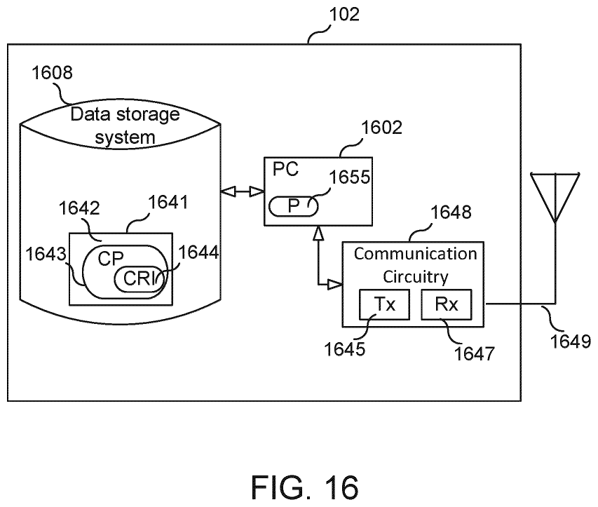

FIG. 16 is a block diagram of UE 102, according to some aspects. As shown in FIG. 16, UE 102 may comprise: processing circuitry (PC) 1602, which may include one or more processors (P) 1655 (e.g., one or more general purpose microprocessors and/or one or more other processors, such as an application specific integrated circuit (ASIC), field-programmable gate arrays (FPGAs), and the like); communication circuitry 1648, which is coupled to an antenna arrangement 1649 comprising one or more antennas and which comprises a transmitter (Tx) 1645 and a receiver (Rx) 1647 for enabling UE 102 to transmit data and receive data (e.g., wirelessly transmit/receive data); and a local storage unit (a.k.a., “data storage system”) 1608, which may include one or more non-volatile storage devices and/or one or more volatile storage devices. In some aspects where PC 1602 includes a programmable processor, a computer program product (CPP) 1641 may be provided. CPP 1641 includes a computer readable medium (CRM) 1642 storing a computer program (CP) 1643 comprising computer readable instructions (CRI) 1644. CRM 1642 may be a non-transitory computer readable medium, such as, magnetic media (e.g., a hard disk), optical media, memory devices (e.g., random access memory, flash memory), and the like. In some aspects, the CRI 1644 of computer program 1643 is configured such that when executed by PC 1602, the CRI causes UE 102 to perform steps described herein (e.g., steps described herein with reference to the flow charts). In other aspects, UE 102 may be configured to perform steps described herein without the need for code. That is, for example, PC 1602 may consist merely of one or more ASICs. Hence, the features of the aspects described herein may be implemented in hardware and/or software.

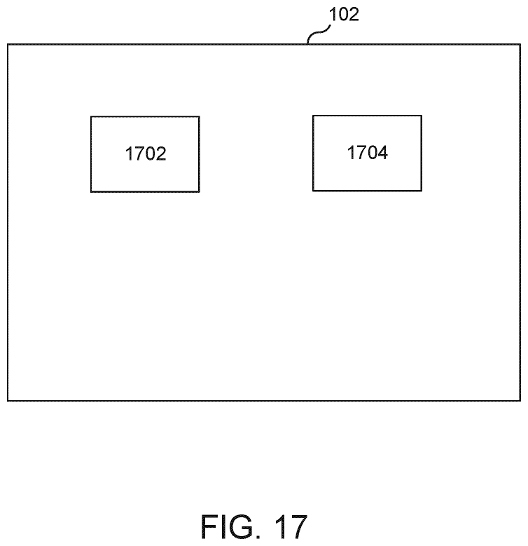

FIG. 17 is a block diagram of a user equipment (UE) 102 according to some aspects. As shown in FIG. 17, in some aspects, the UE 102 may include a selection module (1702) for selecting a physical random access channel (PRACH) configuration from a group including at least a first PRACH configuration associated with a first group and a second PRACH configuration associated with a second group. The first and second PRACH configurations may be different. As shown in FIG. 17, in some aspects, the UE 102 may include a transmission module (1704) transmitting a random access preamble in accordance with the selected PRACH configuration as part of a contention free random access procedure.

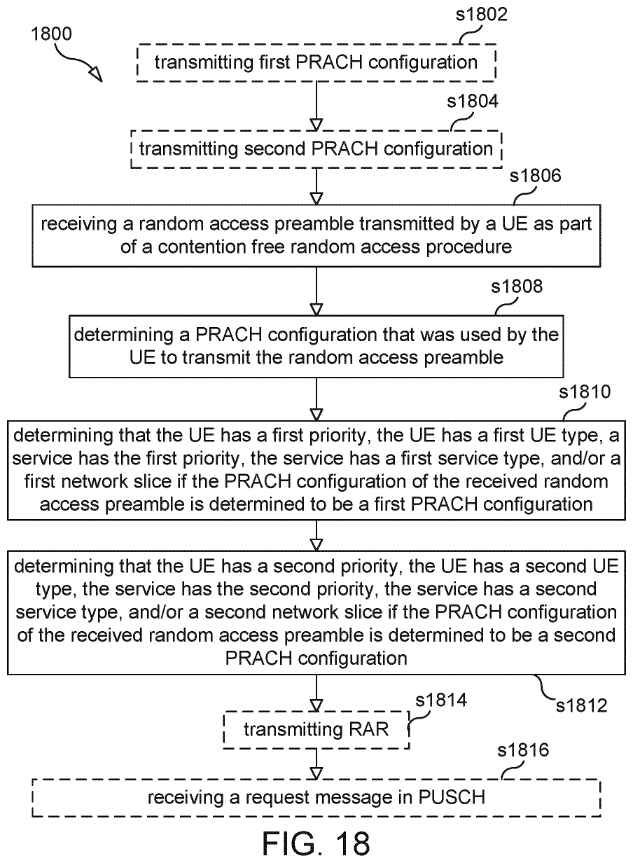

FIG. 18 illustrates a process 1800 performed by a network node 104 according to some aspects. In some aspects, the process 1800 may include optional steps 1802 and 1804 in which the network node 104 transmits first and second physical random access channel (PRACH) configurations, respectively. In some aspects, the first and second PRACH configurations may be transmitted as part of a system information block (e.g., SIB1).

In some aspects, the process 1800 may include a step 1806 in which the network node 104 receives a random access preamble transmitted by a user equipment (UE) 102 as part of a contention free random access procedure. In some aspects (e.g., 2-step random access procedure aspects), in the step 1806, the network node 104 may receive a request message in physical uplink shared channel (PUSCH) with the random access preamble.

In some aspects, the process 1800 may include a step 1808 in which the network node 104 determines a PRACH configuration that was used by the UE 102 to transmit the random access preamble.

In some aspects, the process 1800 may include a step 1810 in which the network node 104 determines that the UE 102 has a first priority, the UE has a first UE type, a service has the first priority, the service has a first service type, and/or a first network slice if the PRACH configuration of the received random access preamble is determined to be a first PRACH configuration.

In some aspects, the process 1800 may include a step 1812 in which the network node 104 determines that the UE 102 has a second priority, the UE has a second UE type, the service has the second priority, the service has a second service type, and/or a second network slice if the PRACH configuration of the received random access preamble is determined to be a second PRACH configuration. In some aspects, the first and second PRACH configurations may be different. In some aspects, the first and second PRACH configurations may be different in at least one of the following parameters: valid PRACH occasions, PRACH configuration periodicities, preamble formats, configured preamble indexes per random access occasion, transmitting power, and power ramping step.

In some aspects, the UE 102 may be attempting to establish a connection with the network node 104 to obtain the service. In some aspects, the service may be an emergency call, a mission critical (MC) service, a multimedia priority service, a mobile broadband (MBB) service, an enhanced mobile broadband (eMBB) service, a vehicle-to-everything (V2X) service, a television broadcast, a small data transmission (SDT) service, or an air-to-ground communication (A2G) service.

In some aspects, the UE 102 may be determined to have the first priority in step 1810 if the PRACH configuration of the received random access preamble is determined to be a first PRACH configuration, the UE 102 may be determined to have the second priority in step 1812 if the PRACH configuration of the received random access preamble is determined to be a second PRACH configuration, and the second priority may be higher than the first priority.

In some aspects, the UE 102 may be determined to have the first UE type in step 1810 if the PRACH configuration of the received random access preamble is determined to be a first PRACH configuration, the UE 102 may be determined to have the second UE type in step 1812 if the PRACH configuration of the received random access preamble is determined to be a second PRACH configuration, and the first and second UE types may be different. In some aspects, the first and second UE types may be subscription types. In some aspects, the second UE type may be a mission critical (MC) UE or a multimedia priority UE. In some aspects, the second UE type may be one of a set of one or more UE types. In some aspects, the set of one or more UE types may include a mission critical (MC) UE and/or a multimedia priority UE. In some aspects, the first UE type may be one of a set of one or more different UE types.

In some aspects, the service may be determined to have the first priority in step 1810 if the PRACH configuration of the received random access preamble may be determined to be a first PRACH configuration, the service may be determined to have the second priority in step 1812 if the PRACH configuration of the received random access preamble is determined to be a second PRACH configuration, and the second priority may be higher than the first priority.

In some aspects, the service may be determined to have the first service type in step 1810 if the PRACH configuration of the received random access preamble is determined to be a first PRACH configuration, the service may be determined to have the second service type in step 1812 if the PRACH configuration of the received random access preamble is determined to be a second PRACH configuration, and the first and second service types may be different. In some aspects, the second service type may be a mission critical (MC) service. In some aspects, the second service type may be one of a set of one or more service types. In some aspects, the set of one or more service types may include a mission critical (MC) service.

In some aspects, the first network slice may be determined in step 1810 if the PRACH configuration of the received random access preamble is determined to be a first PRACH configuration, the second network slice may be determined in step 1812 if the PRACH configuration of the received random access preamble is determined to be a second PRACH configuration, and the first and second network slices may be different. In some aspects, the second network slice may be one of a set of one or more network slices.

In some aspects, the process 1800 may include an optional step 1814 in which the network node 104, in response to receiving the random access preamble, transmits a random access response (RAR). In some aspects (e.g., 2-step random access procedure aspects), the transmitted RAR may include a UE identifier assignment, timing advance information, and a contention resolution message.

In some aspects (e.g., 4-step random access procedure aspects), the process 1800 may include an optional step 1816 in which the network node 104 receives a request message (e.g., for requesting terminal identification and radio resource control (RRC) connection establishment) that was conveyed by the UE 102 in physical uplink shared channel (PUSCH).

In some aspects, the process 1800 may further include transmitting a random access preamble assignment for a contention free random access procedure. In some aspects, the UE 102 may transmit the random access preamble in accordance with the random access preamble assignment.

In some aspects (e.g., 2-step random access procedure aspects), the process 1800 may further include: transmitting a physical uplink shared channel (PUSCH) assignment for the contention free random access procedure. In some aspects (e.g., 2-step random access procedure aspects), the step 1806 may include receiving a request message transmitted by the UE 102 in PUSCH. In some aspects, the request message may be transmitted in PUSCH with the random access preamble. In some aspects, the UE 102 may transmit the request message in accordance with the PUSCH assignment.

In some aspects, the process 1800 may further include determining that the UE 102 has a third priority, the UE 102 has a third UE type, the service has the third priority, the service has a third service type, and/or a third network slice if the PRACH configuration of the received random access preamble is determined to be a third PRACH configuration. In some aspects, the first, second, and third random access preamble configurations may be different, and the third priority may be higher than the first and second priorities. In some aspects, the process 1800 may further include transmitting a system information block including the first, second, and third PRACH configurations.

In some aspects, the first PRACH configuration may include a first list of PRACH occasions, the second PRACH configuration may include a second list of PRACH occasions, and the first and second lists are different. In some aspects, determining the PRACH configuration of the received random access preamble in step 1808 may include determining whether the received random access preamble was transmitted in a PRACH occasion of the first list or a PRACH occasion of the second list. In some aspects, the second list of PRACH occasions may include one or more PRACH occasions masked by a PRACH mask. In some aspects, the first list of PRACH occasions may be associated with a first list of synchronization signals/physical broadcast channel block (SSB) resources, the second list of PRACH occasions may be associated with a second list of SSB resources, and the first and second lists of SSB resources may be different. In some aspects, determining the PRACH configuration of the received random access preamble in step 1808 may include determining whether the received random access preamble was transmitted with one or more SSB resources in the first list of SSB resources or one or more SSB resources in the second list of SSB resources.

In some aspects, the first list of PRACH occasions may be associated with a first list of channel state information-reference signal (CSI-RS) resources, the second list of PRACH occasions may be associated with a second list of CSI-RS resources, and the first and second lists of CSI-RS resources may be different. In some aspects, determining the PRACH configuration of the received random access preamble in step 1808 may include determining whether the received random access preamble was transmitted with one or more CSI-RS resources in the first list of CSI-RS resources or one or more CSI-RS resources in the second list of CSI-RS resources. In some aspects, the first and second lists of PRACH occasions may be defined in an information element (IE) for random access ConfigDedicated information element (IE).

In some aspects, the first PRACH configuration may have a first set of preamble indexes per PRACH occasion, the second PRACH configuration may have a second set of preamble indexes per PRACH occasion, the first and second sets of preamble indexes may not overlap. In some aspects, determining the PRACH configuration of the received random access preamble in step 1808 may include determining whether a preamble index of the received random access preamble is in the first set or the second set. In some aspects, the first set of preamble indexes may be associated with a first list of synchronization signals/physical broadcast channel block (SSB) resources, the second set of preamble indexes may be associated with a second list of SSB resources, and the first and second lists of SSB resources may be different. In some aspects, determining the PRACH configuration of the received random access preamble in step 1808 may include determining whether the received random access preamble was transmitted with one or more SSB resources in the first list of SSB resources or one or more SSB resources in the second list of SSB resources. In some aspects, the first set of preamble indexes may be associated with a first list of channel state information-reference signal (CSI-RS) resources, the second set of preamble indexes may be associated with a second list of CSI-RS resources, and the first and second lists of CSI-RS resources may be different. In some aspects, determining the PRACH configuration of the received random access preamble in step 1808 may include determining whether the received random access preamble was transmitted with one or more CSI-RS resources in the first list of CSI-RS resources or one or more CSI-RS resources in the second list of CSI-RS resources. In some aspects, the first and second sets of preamble indexes may be defined in an information element (IE) for random access ConfigDedicated information element (IE).

In some aspects (e.g., 2-step random access procedure aspects), the first PRACH configuration may include a first physical uplink shared channel (PUSCH) resource configuration, the second PRACH configuration may include a second PUSCH resource configuration, and the first and second PUSCH resource configurations may be different. In some aspects, the step 1806 may further include receiving a request message transmitted by the UE 102 in PUSCH. In some aspects, the request message may be transmitted in PUSCH with the random access preamble. In some aspects, determining the PRACH configuration of the received random access preamble in step 1808 may include determining whether the received request message was transmitted with the first PUSCH resource configuration or the second PUSCH resource configuration. In some aspects, the first and second PUSCH resource configurations may be different with respect to: (i) a demodulation reference signal (DMRS) resource for msgA PUSCH including a DMRS port and/or a DMRS sequence, (ii) a time and/or frequency resource for msgA PUSCH, (iii) power control related parameters for msgA PUSCH including a power ramping step size, a power ramping counter, a power offset relative to the preamble received target power, a power scaling factor for scaling an estimated path loss, and/or a transmit power command (TPC), (iv) a listen before talk (LBT) type of msgA PUSCH, (v) a CP extension of msgA PUSCH, (vi) a frequency hopping configuration of msgA PUSCH, (vii) a waveform of msgA PUSCH, (viii) an interlace configuration of msgA PUSCH, and/or (ix) MCS configuration of msgA PUSCH.

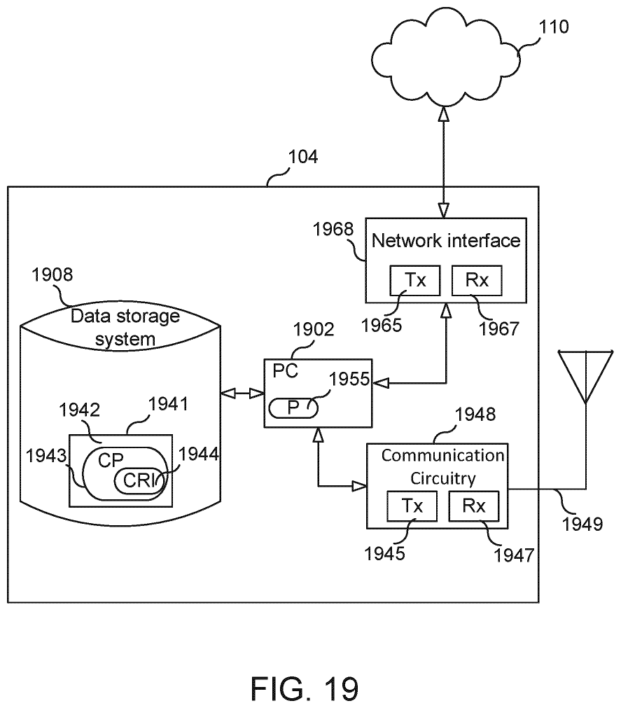

FIG. 19 is a block diagram of a network node 104, according to some aspects. As shown in FIG. 19, the network node 104 may comprise: processing circuitry (PC) 1902, which may include one or more processors (P) 1955 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., the network node 104 may be a distributed computing apparatus); a network interface 1968 comprising a transmitter (Tx) 1965 and a receiver (Rx) 1967 for enabling the network node 104 to transmit data to and receive data from other nodes connected to a network 110 (e.g., an Internet Protocol (IP) network) to which network interface 1968 is connected; communication circuitry 1948, which is coupled to an antenna arrangement 1949 comprising one or more antennas and which comprises a transmitter (Tx) 1945 and a receiver (Rx) 1947 for enabling the network node 104 to transmit data and receive data (e.g., wirelessly transmit/receive data); and a local storage unit (a.k.a., “data storage system”) 1908, which may include one or more non-volatile storage devices and/or one or more volatile storage devices. In aspects where PC 1902 includes a programmable processor, a computer program product (CPP) 1941 may be provided. CPP 1941 includes a computer readable medium (CRM) 1942 storing a computer program (CP) 1943 comprising computer readable instructions (CRI) 1944. CRM 1942 may be a non-transitory computer readable medium, such as, magnetic media (e.g., a hard disk), optical media, memory devices (e.g., random access memory, flash memory), and the like. In some aspects, the CRI 1944 of computer program 1943 is configured such that when executed by PC 1902, the CRI causes the network node 104 to perform steps described herein (e.g., steps described herein with reference to the flow charts). In other aspects, the network node 104 may be configured to perform steps described herein without the need for code. That is, for example, PC 1902 may consist merely of one or more ASICs. Hence, the features of the aspects described herein may be implemented in hardware and/or software.

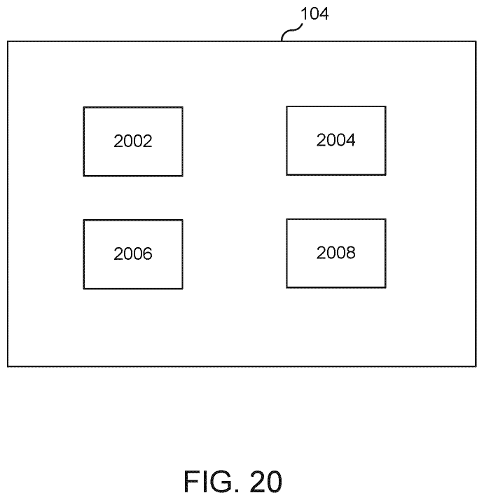

FIG. 20 is a block diagram of a network node 104 according to some aspects. As shown in FIG. 20, in some aspects, the network node 104 may include a receiving module (2002) for receiving a random access preamble transmitted by a user equipment (UE) (102) as part of a contention free random access procedure. In some aspects, the network node 104 may include a first determining module (2004) for determining a physical random access channel (PRACH) configuration that was used by the UE to transmit the random access preamble. In some aspects, the network node 104 may include a second determining module (2006) for determining that the UE has a first priority, the UE has a first UE type, a service has the first priority, the service has a first service type, and/or a first network slice if the PRACH configuration of the received random access preamble is determined to be a first PRACH configuration. In some aspects, the network node 104 may include a third determining module (2008) for determining that the UE has a second priority, the UE has a second UE type, the service has the second priority, the service has a second service type, and/or a second network slice if the PRACH configuration of the received random access preamble is determined to be a second PRACH configuration. In some aspects, the first and second PRACH configurations may be different.

### Summary of Embodiments

A1. A method (1500) performed by a user equipment (UE) (102), the method comprising: selecting a physical random access channel (PRACH) configuration from a group including at least a first PRACH configuration associated with a first priority for contention free random access and a second PRACH configuration associated with a second priority for contention free random access, wherein the first and second PRACH configurations are different, the second priority is higher than the first priority, and the selection is based on a priority of the UE; and transmitting a random access preamble in accordance with the selected PRACH configuration.

A2. The method of embodiment A1, further comprising receiving a random access preamble assignment for a contention free random access procedure, wherein the random access preamble is transmitted in accordance with the selected PRACH configuration and the random access preamble assignment.

A3. The method of embodiment A2, further comprising: receiving a physical uplink shared channel (PUSCH) assignment for the contention free random access procedure; and transmitting a request message in PUSCH with the random access preamble, wherein the request message is transmitted in accordance with the PUSCH assignment.

A4. The method of any one of embodiments A1-A3, further comprises receiving a random access response (RAR) to the transmitted random access preamble.

A5. The method of embodiment A4, wherein the RAR includes a UE identifier assignment, timing advance information, and a contention resolution message.

A6. The method of embodiment A4, further comprising, in response to receiving and successfully decoding the RAR, transmitting a request message in physical uplink shared channel (PUSCH).

A7. The method of any one of embodiments A1-A6, further comprising: receiving the first PRACH configuration; and receiving the second PRACH configuration.

A8. The method of embodiment A7, wherein the first and second PRACH configurations are received as part of a system information block.

A9. The method of any one of embodiments A1-A8, wherein the group further includes a third PRACH configuration associated with a third priority, wherein the first, second, and third PRACH configurations are different, and the third priority is higher than the first and second priorities.

A10. The method of embodiment A9, further comprising receiving a system information block including the first, second, and third PRACH configurations.

A11. The method of any one of embodiments A1-A10, wherein the first and second PRACH configurations are different in at least one of the following parameters: valid PRACH occasions, PRACH configuration periodicities, preamble formats, configured preamble indexes per random access occasion, transmitting power, and power ramping step.

A12. The method of any one of embodiments A1-A11, wherein the first PRACH configuration comprises a first list of PRACH occasions, the second PRACH configuration comprises a second list of PRACH occasions, and the first and second lists are different.

A13. The method of embodiment A12, wherein the random access preamble is transmitted in a PRACH occasion of the first list if the selected PRACH configuration is the first PRACH configuration, and the random access preamble is transmitted in a PRACH occasion of the second list if the selected PRACH configuration is the second PRACH configuration.

A14. The method of embodiment A12 or A13, wherein the second list of PRACH occasions includes one or more PRACH occasions masked by a PRACH mask.

A15. The method of any one of embodiments A12-A14, wherein the first list of PRACH occasions is associated with a first list of synchronization signals/physical broadcast channel block (SSB) resources, the second list of PRACH occasions is associated with a second list of SSB resources, and the first and second lists of SSB resources are different.

A16. The method of embodiment A15, wherein the random access preamble is transmitted with one or more SSB resources in the first list of SSB resources if the selected PRACH configuration is the first PRACH configuration, and the random access preamble is transmitted with one or more SSB resources in the second list of SSB resources if the selected PRACH configuration is the second PRACH configuration.

A17. The method of any one of embodiments A12-A16, wherein the first list of PRACH occasions is associated with a first list of channel state information-reference signal (CSI-RS) resources, the second list of PRACH occasions is associated with a second list of CSI-RS resources, and the first and second lists of CSI-RS resources are different.

A18. The method of embodiment A17, wherein the random access preamble is transmitted with one or more CSI-RS resources in the first list of CSI-RS resources if the selected PRACH configuration is the first PRACH configuration, and the random access preamble is transmitted with one or more CSI-RS resources in the second list of CSI-RS resources if the selected PRACH configuration is the second PRACH configuration.

A19. The method of any one of embodiments A12-A17, wherein the first and second lists of PRACH occasions are defined in an information element (IE) for random access ConfigDedicated information element (IE).

A20. The method of any one of embodiments A1-A11, wherein the first PRACH configuration has a first set of preamble indexes per PRACH occasion, the second PRACH configuration has a second set of preamble indexes per PRACH occasion, and the first and second sets of preamble indexes do not overlap.

A21. The method of embodiment A20, wherein the first set of preamble indexes is associated with a first list of synchronization signals/physical broadcast channel block (SSB) resources, the second set of preamble indexes is associated with a second list of SSB resources, and the first and second lists of SSB resources are different.

A22. The method of embodiment A21, wherein the random access preamble is transmitted with one or more SSB resources in the first list of SSB resources if the selected PRACH configuration is the first PRACH configuration, and the random access preamble is transmitted with one or more SSB resources in the second list of SSB resources if the selected PRACH configuration is the second PRACH configuration.

A23. The method of any one of embodiments A20-A22, wherein the first set of preamble indexes is associated with a first list of channel state information-reference signal (CSI-RS) resources, the second set of preamble indexes is associated with a second list of CSI-RS resources, and the first and second lists of CSI-RS resources are different.

A24. The method of embodiment A23, wherein the random access preamble is transmitted with one or more CSI-RS resources in the first list of CSI-RS resources if the selected PRACH configuration is the first PRACH configuration, and the random access preamble is transmitted with one or more CSI-RS resources in the second list of CSI-RS resources if the selected PRACH configuration is the second PRACH configuration.

A25. The method of any one of embodiments A20-A24, wherein the first and second sets of preamble indexes are defined in an information element (IE) for random access ConfigDedicated information element (IE).

A26. The method of any one of embodiments A1-A25, wherein the first PRACH configuration includes a first physical uplink shared channel (PUSCH) resource configuration, the second PRACH configuration includes a second PUSCH resource configuration, and the first and second PUSCH resource configurations are different.

A27. The method of embodiment A26, further comprising transmitting a request message in PUSCH with the random access preamble, wherein the request message is transmitted with the first PUSCH resource configuration if the selected PRACH configuration is the first PRACH configuration, and the request message is transmitted with the second PUSCH resource configuration if the selected PRACH configuration is the second PRACH configuration.

A28. The method of embodiment A26 or A27, wherein the first and second PUSCH resource configurations are different with respect to: (i) a demodulation reference signal (DMRS) resource for msgA PUSCH including a DMRS port and/or a DMRS sequence, (ii) a time and/or frequency resource for msgA PUSCH, (iii) power control related parameters for msgA PUSCH including a power ramping step size, a power ramping counter, a power offset relative to the preamble received target power, a power scaling factor for scaling an estimated path loss, and/or a transmit power command (TPC), (iv) a listen before talk (LBT) type of msgA PUSCH, (v) a CP extension of msgA PUSCH, (vi) a frequency hopping configuration of msgA PUSCH, (vii) a waveform of msgA PUSCH, (viii) an interlace configuration of msgA PUSCH, and/or (ix) MCS configuration of msgA PUSCH.

B1. A user equipment (UE) (102) adapted to: select a physical random access channel (PRACH) configuration from a group including at least a first PRACH configuration associated with a first priority for contention free random access and a second PRACH configuration associated with a second priority for contention free random access, wherein the first and second PRACH configurations are different, the second priority is higher than the first priority, and the selection is based on a priority of the UE; and transmit a random access preamble in accordance with the selected PRACH configuration.

C1. A method (1800) performed by a network node (104), the method comprising: receiving a random access preamble transmitted by a user equipment (UE) (102); determining a physical random access channel (PRACH) configuration that was used by the UE to transmit the random access preamble; determining that the UE has a first priority for contention free random access if the PRACH configuration of the received random access preamble is determined to be a first PRACH configuration; and determining that the UE has a second priority if the PRACH configuration of the received random access preamble is determined to be a second PRACH configuration, wherein the first and second PRACH configurations are different, and the second priority is higher than the first priority.

C2. The method of embodiment C1, further comprising transmitting a random access preamble assignment for a contention free random access procedure, wherein the random access preamble is transmitted in accordance with the random access preamble assignment.

C3. The method of embodiment C2, further comprising: transmitting a physical uplink shared channel (PUSCH) assignment for the contention free random access procedure; and receiving a request message transmitted by the UE in PUSCH, wherein the request message is transmitted in PUSCH with the random access preamble, and the request message is transmitted in accordance with the PUSCH assignment.

C4. The method of any one of embodiments C1-C3, further comprises, in response to receiving the random access preamble, transmitting a random access response (RAR).

C5. The method of embodiment C4, wherein the transmitted RAR includes a UE identifier assignment, timing advance information, and a contention resolution message.

C6. The method of embodiment C4, further comprising receiving a request message that was conveyed by the UE in physical uplink shared channel (PUSCH).

C7. The method of any one of embodiments C1-C6, further comprising: transmitting the first PRACH configuration; and transmitting the second PRACH configuration.

C8. The method of embodiment C7, wherein the first and second PRACH configurations are transmitted as part of a system information block.

C9. The method of any one of embodiments C1-C8, further comprising determining that the UE has a third priority if the PRACH configuration of the received random access preamble is determined to be a third PRACH configuration, wherein the first, second, and third random access preamble configurations are different, and the third priority is higher than the first and second priorities.

C10. The method of embodiment C9, further comprising transmitting a system information block including the first, second, and third PRACH configurations.

C11. The method of any one of embodiments C1-C10, wherein the first and second PRACH configurations are different in at least one of the following parameters: valid PRACH occasions, PRACH configuration periodicities, preamble formats, configured preamble indexes per random access occasion, transmitting power, and power ramping step.

C12. The method of any one of embodiments C1-C11, wherein the first PRACH configuration comprises a first list of PRACH occasions, the second PRACH configuration comprises a second list of PRACH occasions, and the first and second lists are different.

C13. The method of embodiment C12, wherein determining the PRACH configuration of the received random access preamble comprises determining whether the received random access preamble was transmitted in a PRACH occasion of the first list or a PRACH occasion of the second list.

C14. The method of embodiment C12 or C13, wherein the second list of PRACH occasions includes one or more PRACH occasions masked by a PRACH mask.

C15. The method of any one of embodiments C12-C14, wherein the first list of PRACH occasions is associated with a first list of synchronization signals/physical broadcast channel block (SSB) resources, the second list of PRACH occasions is associated with a second list of SSB resources, and the first and second lists of SSB resources are different.

C16. The method of embodiment C15, wherein determining the PRACH configuration of the received random access preamble comprises determining whether the received random access preamble was transmitted with one or more SSB resources in the first list of SSB resources or one or more SSB resources in the second list of SSB resources.

C17. The method of any one of embodiments C12-C16, wherein the first list of PRACH occasions is associated with a first list of channel state information-reference signal (CSI-RS) resources, the second list of PRACH occasions is associated with a second list of CSI-RS resources, and the first and second lists of CSI-RS resources are different.

C18. The method of embodiment C17, wherein determining the PRACH configuration of the received random access preamble comprises determining whether the received random access preamble was transmitted with one or more CSI-RS resources in the first list of CSI-RS resources or one or more CSI-RS resources in the second list of CSI-RS resources.

C19. The method of any one of embodiments C12-C18, wherein the first and second lists of PRACH occasions are defined in an information element (IE) for random access ConfigDedicated information element (IE).

C20. The method of any one of embodiments C1-C11, wherein the first PRACH configuration has a first set of preamble indexes per PRACH occasion, the second PRACH configuration has a second set of preamble indexes per PRACH occasion, the first and second sets of preamble indexes do not overlap, and determining the PRACH configuration of the received random access preamble comprises determining whether a preamble index of the received random access preamble is in the first set or the second set.

C21. The method of embodiment C20, wherein the first set of preamble indexes is associated with a first list of synchronization signals/physical broadcast channel block (SSB) resources, the second set of preamble indexes is associated with a second list of SSB resources, and the first and second lists of SSB resources are different.

C22. The method of embodiment C21, wherein determining the PRACH configuration of the received random access preamble comprises determining whether the received random access preamble was transmitted with one or more SSB resources in the first list of SSB resources or one or more SSB resources in the second list of SSB resources.

C23. The method of any one of embodiments C20-C22, wherein the first set of preamble indexes is associated with a first list of channel state information-reference signal (CSI-RS) resources, the second set of preamble indexes is associated with a second list of CSI-RS resources, and the first and second lists of CSI-RS resources are different.

C24. The method of embodiment C23, wherein determining the PRACH configuration of the received random access preamble comprises determining whether the received random access preamble was transmitted with one or more CSI-RS resources in the first list of CSI-RS resources or one or more CSI-RS resources in the second list of CSI-RS resources.

C25. The method of any one of embodiments C20-C24, wherein the first and second sets of preamble indexes are defined in an information element (IE) for random access ConfigDedicated information element (IE).

C26. The method of any one of embodiments C1-C25, wherein the first PRACH configuration includes a first physical uplink shared channel (PUSCH) resource configuration, the second PRACH configuration includes a second PUSCH resource configuration, and the first and second PUSCH resource configurations are different.

C27. The method of embodiment C26, further comprising receiving a request message transmitted by the UE in PUSCH, wherein the RRC connection establishment request is transmitted in PUSCH with the random access preamble, and determining the PRACH configuration of the received random access preamble comprises determining whether the received request message was transmitted with the first PUSCH resource configuration or the second PUSCH resource configuration.

C28. The method of embodiment C26 or C27, wherein the first and second PUSCH resource configurations are different with respect to: (i) a demodulation reference signal (DMRS) resource for msgA PUSCH including a DMRS port and/or a DMRS sequence, (ii) a time and/or frequency resource for msgA PUSCH, (iii) power control related parameters for msgA PUSCH including a power ramping step size, a power ramping counter, a power offset relative to the preamble received target power, a power scaling factor for scaling an estimated path loss, and/or a transmit power command (TPC), (iv) a listen before talk (LBT) type of msgA PUSCH, (v) a CP extension of msgA PUSCH, (vi) a frequency hopping configuration of msgA PUSCH, (vii) a waveform of msgA PUSCH, (viii) an interlace configuration of msgA PUSCH, and/or (ix) MCS configuration of msgA PUSCH.

D1. A network node (104) adapted to: receive a random access preamble transmitted by a user equipment (UE) (102); determine a physical random access channel (PRACH) configuration that was used by the UE to transmit the random access preamble; determine that the UE has a first priority for contention free random access if the PRACH configuration of the received random access preamble is determined to be a first PRACH configuration; and determine that the UE has a second priority if the PRACH configuration of the received random access preamble is determined to be a second PRACH configuration, wherein the first and second PRACH configurations are different, and the second priority is higher than the first priority.

E1. A computer program comprising instructions for adapting an apparatus to perform the method of any one of embodiments A1-A28 and C1-C28.

F1. A carrier containing the computer program of embodiment E1, wherein the carrier is one of an electronic signal, optical signal, radio signal, or compute readable storage medium.

G1. An apparatus (102 or 104), the apparatus comprising: processing circuitry (1602 or 1902); and a memory (1642 and 1942), said memory containing instructions (1644 and 1944) executable by said processing circuitry, whereby said apparatus is operative to perform the method of any one of the embodiments A1-A28 and C1-C28.

H1. An apparatus (102) comprising: a selection module (1702) for selecting a physical random access channel (PRACH) configuration from a group including at least a first PRACH configuration associated with a first priority for contention free random access and a second PRACH configuration associated with a second priority for contention free random access, wherein the first and second PRACH configurations are different, the second priority is higher than the first priority, and the selection is based on a priority of the UE; and a transmission module (1704) transmitting a random access preamble in accordance with the selected PRACH configuration.

I1. An apparatus (2000) comprising: a receiving module (2002) for receiving a random access preamble transmitted by a user equipment (UE) (102); a first determining module (2004) for determining a physical random access channel (PRACH) configuration that was used by the UE to transmit the random access preamble; a second determining module (2006) for determining that the UE has a first priority for contention free random access if the PRACH configuration of the received random access preamble is determined to be a first PRACH configuration; and a third determining module (2008) for determining that the UE has a second priority if the PRACH configuration of the received random access preamble is determined to be a second PRACH configuration, wherein the first and second PRACH configurations are different, and the second priority is higher than the first priority.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a user equipment (UE), the method comprising:
selecting a physical random access channel (PRACH) configuration from a group including at least a first PRACH configuration associated with a first group and a second PRACH configuration associated with a second group, wherein the first and second PRACH configurations are different; and
transmitting a random access preamble in accordance with the selected PRACH configuration as part of a contention free random access procedure.

2. The method of claim 1, wherein the first PRACH configuration comprises a first list of PRACH occasions, the second PRACH configuration comprises a second list of PRACH occasions, and the first and second lists are different.

3. (canceled)

4. (canceled)

5. The method of claim 2, wherein the first list of PRACH occasions is associated with a first list of synchronization signals/physical broadcast channel block (SSB) resources, the second list of PRACH occasions is associated with a second list of SSB resources, and the first and second lists of SSB resources are different.

6. (canceled)

7. The method of claim 2, wherein the first list of PRACH occasions is associated with a first list of channel state information-reference signal (CSI-RS) resources, the second list of PRACH occasions is associated with a second list of CSI-RS resources, and the first and second lists of CSI-RS resources are different.

8. (canceled)

9. The method of claim 1, wherein the first PRACH configuration has a first set of preamble indexes per PRACH occasion, the second PRACH configuration has a second set of preamble indexes per PRACH occasion, and the first and second sets of preamble indexes do not overlap.

10. (canceled)

11. (canceled)

12. The method of claim 9, wherein the first set of preamble indexes is associated with a first list of channel state information-reference signal (CSI-RS) resources, the second set of preamble indexes is associated with a second list of CSI-RS resources, and the first and second lists of CSI-RS resources are different.

13. (canceled)

14. The method of claim 1, wherein the first PRACH configuration includes a first physical uplink shared channel (PUSCH) resource configuration, the second PRACH configuration includes a second PUSCH resource configuration, and the first and second PUSCH resource configurations are different.

15. (canceled)

16. The method of claim 1, wherein the selection is based on a priority of the UE, the first group is associated with a first priority, the second group is associated with a second priority, the second priority is higher than the first priority, the first PRACH configuration is selected if the UE has the first priority, and the second PRACH configuration is selected if the UE has the second priority.

17. The method of claim 1, wherein the selection is based on a type of the UE, the second group is associated with a set of one or more UE types, and the second PRACH configuration is selected if the type of the UE is within the set of one or more UE types.

18. The method of claim 1, wherein the method is for establishing a connection with a network node (104) to obtain a service, and the selection is based on a priority or a type of the service.

19. The method of claim 1, wherein the selection is based on a network slice identification (ID).

20. A user equipment (UE) adapted to:
select a physical random access channel (PRACH) configuration from a group including at least a first PRACH configuration associated with a first group and a second group, wherein the first and second PRACH configurations are different; and
transmit a random access preamble in accordance with the selected PRACH configuration as part of a contention free random access procedure.

21. A method performed by a network node, the method comprising:
receiving a random access preamble transmitted by a user equipment (UE) as part of a contention free random access procedure;
determining a physical random access channel (PRACH) configuration that was used by the UE to transmit the random access preamble;
determining that the UE has a first priority, the UE has a first UE type, a service has the first priority, the service has a first service type, and/or a first network slice if the PRACH configuration of the received random access preamble is determined to be a first PRACH configuration; and
determining that the UE has a second priority, the UE has a second UE type, the service has the second priority, the service has a second service type, and/or a second network slice if the PRACH configuration of the received random access preamble is determined to be a second PRACH configuration, wherein the first and second PRACH configurations are different.

22. The method of claim 21, wherein the first PRACH configuration comprises a first list of PRACH occasions, the second PRACH configuration comprises a second list of PRACH occasions, and the first and second lists are different.

23. (canceled)

24. (canceled)

25. The method of claim 22, wherein the first list of PRACH occasions is associated with a first list of synchronization signals/physical broadcast channel block (SSB) resources, the second list of PRACH occasions is associated with a second list of SSB resources, and the first and second lists of SSB resources are different.

26. (canceled)

27. The method of claim 22, wherein the first list of PRACH occasions is associated with a first list of channel state information-reference signal (CSI-RS) resources, the second list of PRACH occasions is associated with a second list of CSI-RS resources, and the first and second lists of CSI-RS resources are different.

28. (canceled)

29. The method of claim 21, wherein the first PRACH configuration has a first set of preamble indexes per PRACH occasion, the second PRACH configuration has a second set of preamble indexes per PRACH occasion, the first and second sets of preamble indexes do not overlap, and determining the PRACH configuration of the received random access preamble comprises determining whether a preamble index of the received random access preamble is in the first set or the second set.

30. The method of claim 29, wherein the first set of preamble indexes is associated with a first list of synchronization signals/physical broadcast channel block (SSB) resources, the second set of preamble indexes is associated with a second list of SSB resources, and the first and second lists of SSB resources are different.

31. (canceled)

32. The method of claim 29, wherein the first set of preamble indexes is associated with a first list of channel state information-reference signal (CSI-RS) resources, the second set of preamble indexes is associated with a second list of CSI-RS resources, and the first and second lists of CSI-RS resources are different.

33. (canceled)

34. The method of claim 21, wherein the first PRACH configuration includes a first physical uplink shared channel (PUSCH) resource configuration, the second PRACH configuration includes a second PUSCH resource configuration, and the first and second PUSCH resource configurations are different.

35. (canceled)

36. The method of claim 21, wherein the method comprises at least one of the following features:
the UE is determined to have the first priority if the PRACH configuration of the received random access preamble is determined to be a first PRACH configuration, the UE is determined to have the second priority if the PRACH configuration of the received random access preamble is determined to be a second PRACH configuration, and the second priority is higher than the first priority;
the UE is determined to have the first UE type if the PRACH configuration of the received random access preamble is determined to be a first PRACH configuration, the UE is determined to have the second UE type if the PRACH configuration of the received random access preamble is determined to be a second PRACH configuration, and the first and second UE types are different;
the service is determined to have the first priority or the first service type if the PRACH configuration of the received random access preamble is determined to be a first PRACH configuration, the is determined to have the second priority or the second service type if the PRACH configuration of the received random access preamble is determined to be a second PRACH configuration, and the second priority is higher than the first priority; and
the first network slice is determined if the PRACH configuration of the received random access preamble is determined to be a first PRACH configuration, the second network slice is determined if the PRACH configuration of the received random access preamble is determined to be a second PRACH configuration, and the first and second network slices are different.

37-39. (canceled)

40. A network node adapted to:
receive a random access preamble transmitted by a user equipment (UE) as part of a contention free random access procedure;
determine a physical random access channel (PRACH) configuration that was used by the UE to transmit the random access preamble;
determine that the UE has a first priority, the UE has a first UE type, a service has the first priority, the service has a first service type, and/or a first network slice if the PRACH configuration of the received random access preamble is determined to be a first PRACH configuration; and
determine that the UE has a second priority, the UE has a second UE type, the service has the second priority, the service has a second service type, and/or a second network slice if the PRACH configuration of the received random access preamble is determined to be a second PRACH configuration, wherein the first and second PRACH configurations are different.
